(19) United States
(12) Patent Application Publication
(10) Pub. No.: US 2025/0340173 A1
(43) Pub. Date: Nov. 6, 2025

(54) ROOF RACK FOR A VEHICLE

(71) Applicant: Thule Sweden AB, Hillerstorp (SE)

(72) Inventors: Fredrik Bergman, Vaggeryd (SE); Jonas Poulsen, Värnamo (SE); Wilhelm Larsson, Värnamo (SE)

(21) Appl. No.: 18/855,285

(22) PCT Filed: Apr. 4, 2023
(86) PCT No.: PCT/EP2023/058768

§ 371 Date: Oct. 8, 2024

(30) Foreign Application Priority Data
Apr. 11, 2022 (EP) 22167552.3

(51) Int. Cl. B60R 9/058

(52) U.S. Cl. CPC B60R 9/058

(57) ABSTRACT

A roof rack for a vehicle includes a roof rack foot member having a vehicle roof support surface, an engagement member configured to engage a vehicle bracket of the vehicle, a tightening member configured to tighten the engagement member, and a cross bar member configured to carry a load on the vehicle. The tightening member is configured to couple to the roof rack foot member and the cross bar member to secure the roof rack to the vehicle. The tightening member includes a first engagement section and the engagement member comprises a second engagement section. The first engagement section and the second engagement section are configured to mate and tighten the engagement member to the vehicle bracket.

### TECHNICAL FIELD

The present disclosure relates to a roof rack for a vehicle. The present disclosure further relates to a vehicle roof, a roof rack alignment tool and an end cap for a roof rack cross bar member of a roof rack.

### BACKGROUND

Roof racks comprising cross bars are known for providing improved load carrying capacity for vehicles.

A roof rack for a vehicle typically includes a roof rack crossbar, i.e. a cross bar member, and two roof rack foot members configured for attachment to the vehicle. There are different types of roof racks and roof rack foot members. For example, roof rack foot members may be configured for attachment to a guide rail or the like provided on the roof of the vehicle. Thereby, the roof rack may be provided at any position along the extension of the guide rail. Another type of roof rack foot member is the so called fix point roof rack foot, which is configured for attachment to a fix point attachment position on the vehicle. For example, the fix point attachment position is provided on the roof of the vehicle and may be configured as a threaded screw hole close to an edge of the roof which can receive a matching threaded screw for attaching the roof rack foot member to the roof.

One such fix point roof rack foot may be found in EP 3 225 468 A1, which discloses a fix point load carrier foot for a roof rack for a vehicle. The load carrier foot comprises a body and the body comprises a vehicle facing surface and a load carrying bar facing surface. An attachment member is connectable to a fixed connection point on the vehicle and has an attachment position and a release position. Another example of a roof rack with a fix-point attachment configuration can be found in US2019061635.

Even though there exist different types of roof racks with fix point attachment, there is still a strive to develop further improved and/or alternative roof racks for vehicles. For example, there is a strive to develop improved roof rack technology which is advantageous for vehicle roofs comprising glass roof panels.

### SUMMARY

In view of the above, an object of the present disclosure is to provide an improved roof rack for a vehicle, which at least alleviates some of the drawbacks of the prior art, or which at least provides a suitable alternative. Other objects of the present disclosure are to provide an improved method for mounting a roof rack, a vehicle roof, a roof rack alignment tool, and an end cap for a cross bar member of a roof rack, which at least alleviates some of the drawbacks of the prior art, or which at least provides a suitable alternative.

According to a first aspect of the disclosure, the object is achieved by the subject matter in independent claim 1. Advantageous embodiments may be found in the dependent claims and in the accompanying description and drawings.

Hence, according to the first aspect, there is provided a roof rack for a vehicle. The roof rack comprises:
a roof rack foot member comprising a vehicle roof support surface,
an engagement member for engaging with a vehicle bracket of the vehicle,
a tightening member for tightening the engagement member, and
a cross bar member for carrying a load on the vehicle.

The tightening member is coupled to the roof rack foot member and the cross bar member for securing the roof rack to the vehicle. Furthermore, the tightening member comprises a first engagement section and the engagement member comprises a second engagement section, which first and second engagement sections are connectable and correspondingly configured for tightening the engagement member with respect to the vehicle bracket.

By the provision of the roof rack as disclosed herein, especially with respect to the first aspect, an improved roof rack for a vehicle is provided. For example, the configuration of the roof rack as disclosed herein is based on a realization that certain vehicles, especially vehicles comprising narrow channels with vehicle brackets for roof racks and/or vehicles with glass roof panels, may more easily be damaged when mounting a roof rack thereto. For example, for such vehicles there is a large risk of scratching vehicle body panels and damaging glass roof panels during mounting and use of the roof rack. By the roof rack according to the present disclosure, especially according to the first aspect, such risks can be mitigated.

The roof rack has a width extension, a height extension and a longitudinal extension corresponding to a longitudinal extension of the cross bar member.

Optionally, the first engagement section is connectable to the second engagement section in a first connection direction which is different from the height extension, such as a first connection direction which corresponds to the longitudinal extension of the roof rack. By way of example, the first connection direction may be directed away, in the longitudinal extension, from a second roof rack foot member, wherein the second roof rack foot member is provided on an opposite side of the cross bar member. Accordingly, as another example, the first connection direction may be directed towards the second roof rack foot member in the longitudinal extension. By configuring the roof rack with such a connection direction, such as away from the second roof rack foot member in the longitudinal extension, the mounting/dismounting procedure of the roof rack to/from the vehicle may be facilitated. The first connection direction implies that the mounting and/or dismounting procedure for a user can be facilitated. For example, it allows the user to move the tightening member in the first connection direction with one hand while holding in the roof rack foot member and/or the cross bar member with the other hand. This procedure has shown to reduce the risk of damaging the vehicle during mounting.

Optionally, the first engagement section is configured for tightening the engagement member with respect to the vehicle bracket by application of a first tightening force exerted on the second engagement section, wherein the engagement member comprises an engaging portion for engaging with the vehicle bracket of the vehicle and wherein the tightening member is configured for tightening the engaging portion with respect to the vehicle bracket so that a second tightening force is exerted on the engaging portion by the vehicle bracket. The engagement member is optionally configured so that the second tightening force and the first tightening force are substantially aligned. By way of example, the tightening member and the engagement member may be configured such that the second tightening force and the first tightening force are substantially aligned with a centre axis of the tightening member which may correspond to a longitudinal extension of the tightening member. This configuration has shown to significantly reduce the risk of unwanted bending moments on the roof rack foot member. For example, it has been realized that prior art designs have resulted in unwanted bending moments which forces the roof rack foot members inwards towards the vehicle roof. By reducing or avoiding such unwanted bending moments, the risk of damaging vehicle body panels, such as glass roof panels, can be mitigated.

Optionally, the tightening member has a main extension in a longitudinal direction thereof. For example, the tightening member may be a rod-formed member, for example a screw member, for tightening the engagement member to the vehicle bracket. Accordingly, by way of example, and as intimated in the above, the rod-formed tightening member and the engagement member may be configured such that the second tightening force and the first tightening force are substantially aligned with a centre axis of the rod-formed tightening member which corresponds to the longitudinal direction of the rod-formed tightening member. In an alternative embodiment, the tightening member may be a nut member with a centre axis extending through a threaded opening of the nut member.

Optionally, the first engagement section is connectable to the second engagement section by pivoting the tightening member, such as the rod-formed tightening member, about an axis which is substantially perpendicular to a longitudinal extension of the tightening member. For example, the tightening member may be pivotable about an axis which extends along the width extension of the roof rack.

Optionally, the engagement member comprises an engaging portion for engaging with the vehicle bracket of the vehicle and the tightening member comprises a cross bar engaging portion for engaging with the cross bar member, wherein the tightening member is configured to transfer forces along a substantially straight line from the engaging portion to the cross bar engaging portion. This configuration also implies a reduced risk of unwanted bending moments.

Optionally, the second engagement section comprises an opening, such as a slot, for receiving the first engagement section in a first connection direction, such as an opening facing in a direction corresponding to a longitudinal extension of the cross bar member. This implies facilitated mounting/dismounting, mitigating the risk of damaging vehicle body panels, such as glass roof panels. This also results in a more robust connection between the tightening member and the engagement member.

Optionally, the first engagement section is T-formed, L-formed, J-formed, or ball-formed. This implies a robust and reliable mechanical coupling between the first and second engagement sections.

Optionally, the roof rack further comprises a biasing member for biasing the tightening member towards a disconnected state with respect to the engagement member. This configuration implies facilitated mounting/dismounting of the roof rack for a user. For example, this has shown to result in fewer manual operations by the user during mounting/dismounting. For example, the biasing member may be a spring-biased member, such as any one or a combination of a torsion spring exerting a spring force on the tightening member, a helical coil spring, a tension/extension spring and/or a compression spring.

Optionally, the roof rack foot member comprises a guide surface for the tightening member, such as a guide slot, which is adapted to align the first engagement section with respect to the second engagement section and/or adapted to accommodate forces exerted on the tightening member which are directed in directions different from a longitudinal extension of the tightening member. Thereby, a more robust connection between the tightening member and the roof rack foot member can be achieved. Further, aligning the first engagement section with respect to the second engagement section implies a facilitated mounting/dismounting procedure. Accordingly, by way of example, the guide surface may be adapted to guide the tightening member in a guiding direction between a disconnected state and a first connected state, wherein the guiding direction corresponds to a longitudinal extension of the cross bar member.

Optionally, the engagement member is a hook member. For example, the engagement member may be a hook member which is C-formed, formed as the number 9, L-formed, J-formed or U-formed. For example, a C-formed and/or a 9-formed engagement member may imply a configuration which is rigid, robust, easy to manufacture, and/or easy to use by a user, e.g., when mounting the engagement member to the vehicle.

Optionally, the engagement member is detachable from the roof rack. Thereby, the engagement member can be provided in engagement with the vehicle bracket before the roof rack foot member is provided onto the vehicle roof. This implies facilitated mounting/dismounting of the roof rack, reducing the risk of damaging vehicle body panels.

Optionally, the engagement member is a bent sheet-metal element, such as the second engagement section is formed by bent sheet-metal, for example bent to hook into a slot formed in itself, the engagement member is bent to form an open hook end, and/or it is bent to form a closed loop end. Thereby, a robust engagement member can be provided which also is easy to manufacture, implying reduced manufacturing costs.

Optionally, the vehicle roof support surface is adapted to only rest on a vehicle roof surface of the vehicle which is provided on one side with respect to the vehicle bracket, as seen in a direction corresponding to the longitudinal extension of the cross bar member. Additionally, or alternatively, the vehicle roof support surface is adapted to only rest on a vehicle roof surface of the vehicle which is provided on one side with respect to the engagement member, as seen in a direction corresponding to the longitudinal extension of the cross bar member. Thereby, the risk of damaging parts on the other side, such as a glass roof panel, can be mitigated. By way of example, the other side with respect to the vehicle bracket, and/or with respect to the engagement member, may be closer to a second roof rack foot member which is provided on an opposite side of the cross bar member, as seen in a direction corresponding to the longitudinal extension of the cross bar member. For example, the tightening member may be coupled to the roof rack foot member and the cross bar member so that the roof rack foot member is prevented from inclining inwards towards the vehicle, or outwards away from the vehicle, when the tightening member is tightening the engagement member with respect to the vehicle bracket. Still optionally, the tightening member, with its coupling to the roof rack foot member and the cross bar member, and the engagement member, with an engaging portion for engaging with the vehicle bracket, may be configured so that no inwardly or outwardly directed bending moments are exerted at the engaging portion where it engages with the vehicle bracket.

Optionally, the roof rack foot member is configured to avoid contact with an adjacent glass roof panel of the vehicle when the roof rack is mounted on the vehicle.

Optionally, the roof rack foot member comprises an alignment portion for aligning the roof rack foot member with a roof channel of the vehicle. The vehicle bracket is preferably provided in the roof channel of the vehicle. The alignment portion is preferably configured to extend into the roof channel when the roof rack foot member is mounted to the vehicle.

Optionally, the first engagement section is further connectable to the second engagement section in a second connection direction which corresponds to the longitudinal extension of the tightening member.

Optionally, the tightening member and the guide surface, as seen in a sectional plane being perpendicular to a longitudinal extension of the tightening member, are formed to prevent any rotational movement of the tightening member about the longitudinal extension of the tightening member. Thereby, a more robust connection can be provided, preventing the tightening member from rotating with respect to the roof rack foot member.

As mentioned in the above, the tightening member is coupled to the roof rack foot member and the cross bar member for securing the roof rack to the vehicle. For example, the tightening member may be coupled to the roof rack foot member and the cross bar member by providing the tightening member from the cross bar member via the roof rack foot member, such as through the roof rack foot member, so that it engages with the engagement member. As another example, the tightening member may be coupled to the roof rack foot member and the cross bar member by providing the tightening member from the roof rack foot member so that it engages with the engagement member, whereby the roof rack foot member is in engagement with the cross bar member. Accordingly, the tightening member may be directly or indirectly coupled to any one of the roof rack foot member and the cross bar member so that the tightening member secures the roof rack to the vehicle.

Optionally, the tightening member may be accessible for a user from the cross bar member so that the user can tighten the tightening member. As yet another example, the tightening member may be accessible for a user from the roof rack foot member so that the user can tighten the tightening member.

According to a second aspect of the disclosure, the object is achieved by the subject matter in independent claim 19. Advantageous embodiments may be found in the dependent claims and in the accompanying description and drawings.

Hence, there is provided a method for mounting a roof rack to a vehicle. The roof rack is a roof rack according to any one of the embodiments of the first aspect.

The method comprises:
aligning and positioning the engagement member with respect to the vehicle bracket,
positioning the roof rack foot member with the vehicle roof support surface onto the vehicle so that the tightening member is aligned with the engagement member,
tightening the engagement member by use of the tightening member.

By the configuration of the roof rack, and by the mounting method as disclosed herein, the roof rack can be mounted to the vehicle in a manner so that the risk of damaging the vehicle is mitigated. In addition, the mounting procedure can be facilitated. For example, by the roof rack configuration as disclosed herein, there is no need to use a separate foot pad member in-between the vehicle roof and the roof rack foot member. Rather, the roof rack foot member can be provided directly onto the vehicle after the engagement member has been positioned with respect to the vehicle bracket.

According to a third aspect of the disclosure, the object is achieved by a vehicle roof as disclosed herein. Advantageous embodiments may be found in the accompanying description and drawings.

Hence, there is provided a vehicle roof comprising a body side panel, a roof top panel and a roof channel, wherein the roof channel defines an intersection between the body side panel and the roof top panel.

The roof channel comprises a floor and a body side wall. The body side wall is associated with the body side panel, such as forming part of the body side panel, and the roof channel comprises a vehicle bracket, such as a fix-point vehicle bracket, for securing a roof rack to the vehicle roof.

By the provision of a vehicle roof as disclosed herein, mounting of a roof rack to the vehicle roof can be facilitated. In particular, by the provision of the vehicle roof, the roof channel may be kept narrow, while still allowing a roof rack to be secured to the vehicle roof in a robust and reliable manner. In addition, by the configuration as disclosed herein, the risk of damaging the vehicle roof can be mitigated.

Optionally, the vehicle bracket comprises one or more protrusions for an engagement member of the roof rack to engage with, such as to hold around.

Still optionally, the one or more protrusions are configured so that the engagement member of the roof rack can engage with the one or more protrusions in a region of the roof channel which is defined by the body side wall, the floor and a vertical sectional plane extending between an edge of the roof top panel and the floor of the roof channel, and also in a direction corresponding to a longitudinal extension of the body side wall. Thereby, the one or more protrusions will be more easily accessible for the engagement member. This implies reduced risk of damaging the vehicle roof during mounting of the roof rack.

Optionally, the one or more protrusions extend from the body side wall, and/or from the vertical sectional plane, and/or between the body side wall and the vertical sectional plane.

Optionally, the one or more protrusions are T-shaped, mushroom shaped, eye-let shaped, and/or comprises cut-outs, so that the engagement member of the roof rack can engage with the one or more protrusions.

Optionally, the vehicle bracket is attached to the floor, and/or to the body side wall, and/or to a floor portion beneath the roof top panel.

Optionally, the vehicle bracket is inclined, such as L-shaped, as seen in a sectional plane which is perpendicular to a longitudinal extension of the roof channel, with one side attached to the floor and/or the floor portion beneath the roof top panel, and another side optionally attached to the body side wall.

Optionally, the vehicle bracket is U-shaped, as seen in a sectional plane which is perpendicular to a longitudinal extension of the roof channel, such as U-shaped with one or more pin members extending across opposite side flanges of the U-shaped vehicle bracket. This configuration implies a robust connection which also is easily accessible.

Optionally, a portion of the vehicle bracket which comprises means for securing the roof rack to the vehicle is provided substantially in parallel with the body side wall, as seen in a sectional plane which is perpendicular to a longitudinal extension of the roof channel. For example, the portion is provided in parallel with and offset from the body side wall so that a gap is formed between the portion and the body side wall, or in parallel and in connection with the body side wall so that a gap is formed between the portion and the roof top panel. These configurations imply robust connections which also are easily accessible. This further implies reduced risk of damaging certain parts of the vehicle.

Optionally, the vehicle bracket is an integral portion of the body side panel. Thereby, fewer parts may be required for the connection interface between the vehicle roof and the roof rack. In addition, by integrating the vehicle bracket with the body side panel, the risk of damaging e.g. the roof top panel during mounting of the roof rack can be mitigated.

Optionally, the vehicle bracket is formed as an overhang portion of the body side wall, and/or is hook-shaped, as seen in a sectional plane which is perpendicular to a longitudinal extension of the roof channel.

Optionally, the roof top panel is a glass roof panel. More particularly, the vehicle roof configuration as disclosed herein has shown to be advantageous for vehicles having glass roof panels. The risk of damaging such panels during mounting of roof racks has been recognized as a problem which needs attention. By the provision of the vehicle roof and the roof rack as disclosed herein, the risk of damaging glass roof panels can be mitigated.

Optionally, the vehicle bracket is a sheet metal element, such as a bent sheet metal element. Thereby, a cost-efficient and yet robust connection interface can be achieved.

Optionally, the roof channel has a channel opening width in the range of 5-20 mm, such as 5-15 mm or 5-10 mm.

Optionally, the vehicle bracket is configured so that an engagement member of the roof rack can engage with the vehicle bracket by initially lowering the engagement member into the roof channel, followed by moving the engagement member in a substantially horizontal direction, such as in a longitudinal direction of the roof channel and/or in a width direction of the roof channel, so that it engages with the vehicle bracket, and/or by rotating the engagement member about an axis extending in the longitudinal extension of the roof channel so that it engages with the vehicle bracket. Still optionally, the width direction is a direction facing away from the roof top panel and towards the body side wall. Thereby, the risk of damaging the roof top panel can be mitigated.

According to a fourth aspect of the disclosure, the object is achieved by a roof rack alignment tool as disclosed herein. Advantageous embodiments may be found in the accompanying description and drawings.

Hence, there is provided a roof rack alignment tool for aligning an engagement member of a roof rack to a vehicle bracket of a vehicle. The roof rack alignment tool may advantageously be used in the above mentioned method.

The roof rack alignment tool comprises:
a first surface for parallel alignment to a vehicle roof,
a second surface extending at an angle of substantially 90 degrees with respect to the first surface, wherein the second surface is configured to extend into a roof channel of the vehicle roof during use.

By the provision of a roof rack alignment tool as disclosed herein, an engagement member for a roof rack can be mounted to the vehicle roof in a simple and reliable manner, and with a reduced risk of damaging the vehicle roof during mounting. In addition, the roof rack alignment tool allows a user to more easily align the engagement member to the vehicle bracket in the roof channel.

The second surface is typically used for removing a cover of the roof channel when the second surface is extended into the roof channel.

Optionally, the second surface is a folded portion of the first surface. Thereby, the roof rack alignment tool can be manufactured in a facilitated manner, implying cost-efficiency.

Optionally, the second surface forms a cut-out for receiving the engagement member of the roof rack so that the engagement member can engage with the vehicle bracket of the vehicle therethrough. Thereby, the alignment of the engagement member with the vehicle bracket can be facilitated, implying that the mounting procedure will be faster.

Optionally, the second surface is formed by first and second leg portions, wherein the cut-out is formed in-between the first and second leg portions.

Optionally, the roof rack alignment tool further comprises a visual alignment indicator for a user, such as an arrow, wherein the visual alignment indicator is associated with the cut-out, such as provided mid-way in-between the first and second leg portions. Thereby, a user can more rapidly align the roof rack alignment tool with respect to the vehicle bracket. For example, the vehicle roof may comprise a corresponding visual alignment indicator to be matched and aligned with the visual alignment indicator of the roof rack alignment tool.

Optionally, the roof rack alignment tool may further comprise a third surface for aligning the tool with the vehicle bracket of the vehicle, wherein the third surface extends from an outer edge of the second surface, such as the third surface extends substantially in parallel with the vehicle roof when the roof rack alignment tool is in use.

Optionally, the third surface is a folded portion of the second surface. This implies a reduced complexity of the tool, i.e. a cost-efficient configuration.

Optionally, the third surface is formed by at least one auxiliary leg portion, such as the at least one auxiliary leg portion is an extension of the first or the second leg portion.

Optionally, the third surface is formed by two auxiliary leg portions, each auxiliary leg portion being an extension of the respective first and second leg portions.

Optionally, the first, second and third surfaces form a substantially U-shaped tool or a substantially step-shaped tool, as seen in sectional plane defined by a longitudinal extension and a height extension of the tool.

Optionally, the roof rack alignment tool is configured so that it can be moved in a longitudinal direction of the roof channel until it reaches the vehicle bracket of the vehicle, such as until the third surface reaches the vehicle bracket of the vehicle. For example, the third surface may act as a stop surface to stop the movement of the tool when it reaches the vehicle bracket of the vehicle.

Optionally, the roof rack alignment tool further comprises a fourth surface for a user to grip on, wherein the fourth surface extends from an outer edge of the first surface, such as at an angle of substantially 90 degrees with respect to the first surface, and wherein the fourth surface is provided on an opposite side of the roof rack alignment tool with respect to the second surface. Similar to the above, the fourth surface may be a folded portion of the first surface.

Optionally, the fourth surface is extending around a corner of the first surface to increase the rigidity of the fourth surface and/or of the first surface.

Optionally, the fourth surface forms a cut-out for a user to grip in. Thereby, it can be easier for a user to hold and grip the tool.

According to a fifth aspect of the disclosure, the object is achieved by a roof rack for a vehicle, wherein the roof rack comprises an end cap as disclosed herein. Advantageous embodiments may be found in the accompanying description and drawings.

Hence, there is provided a roof rack for a vehicle, comprising:
a cross bar member for carrying a load on the vehicle, wherein the cross bar member comprises a longitudinally extending cross bar channel,
an end cap for the cross bar member, wherein the end cap comprises a cover for covering an end portion of the cross bar channel, and wherein the cross bar channel comprises cover engaging flanges for engaging with an engaging portion of the cover when the end cap is mounted to the cross bar member.

By the provision of the roof rack with the end cap as disclosed herein, any unauthorized removal of the roof rack can be efficiently prevented. In addition, by the configuration of the end cap and the cross bar member, airflow around the cross bar member can be improved, or at least the end cap may not negatively affect the airflow. As such, by the configuration as disclosed herein, disturbing noise emanating from the roof rack during use can be reduced.

Optionally, the cover engaging flanges extend in a longitudinal direction of the cross bar channel. Thereby, a robust and rigid connection to the cover can be achieved.

Still optionally, the cover engaging flanges and the engaging portion of the cover are configured to allow longitudinal sliding movement of the cover in the cross bar channel and to prevent movement of the cover in an upward direction from the cross bar channel. Thereby, the end cap can be more easily mounted to and dismounted from the cross bar member, while still preventing unauthorized removal of the roof rack.

Optionally, the end portion of the cross bar channel comprises a tightening tool engaging portion for tightening and releasing the roof rack to/from the vehicle by use of a tightening tool, wherein the cover is adapted for preventing unauthorized access to the tightening tool engaging portion.

Optionally, when the end cap is mounted to the cross bar member, the cover is substantially flush with an outer surface of the cross bar member. Thereby, airflow around the cross bar member can be improved.

Optionally, the engaging portion of the cover is T-shaped, as seen in a sectional plane being perpendicular to a longitudinal extension of the end cap and the cross bar member. This implies a robust connection with at least two surfaces for preventing removal of the cover.

Optionally, the engaging portion of the cover is provided at a longitudinally outer end of the cover. This implies a further robust and rigid connection of the cover to the cross bar member.

Optionally, the end cap comprises a lock cylinder for locking the end cap to the cross bar member. Thereby, only an authorized user can be able to dismount the end cap from the roof rack.

The disclosure also relates to an end cap for a roof rack cross bar member of a roof rack, comprising:
a cover for covering an end portion of a cross bar channel, wherein the cover comprises an engaging portion for engaging with cover engaging flanges of the cross bar channel when the end cap is mounted to the cross bar member.

Optionally, the engaging portion of the cover is T-shaped, as seen in a sectional plane being perpendicular to a longitudinal extension of the end cap, corresponding to a longitudinal extension of the cross bar member when the end cap is mounted to the cross bar member.

Optionally, the engaging portion of the cover is provided at a longitudinally outer end of the cover.

Optionally, the end cap further comprises a lock cylinder for locking the end cap to the cross bar member.

Optionally, the cover has a length of 20-200 mm, such as 40-150 mm or 40-100 mm.

It shall be noted that all aspects and their different embodiments as disclosed herein are combinable with each other.

In the below, features and feature combinations of the third aspect of the disclosure are presented as a list of items:
1. A vehicle roof (100) comprising a body side panel (102), a roof top panel (110) and a roof channel (120), wherein the roof channel (120) defines an intersection between the body side panel (102) and the roof top panel (110),
   wherein the roof channel (120) comprises a floor (104) and a body side wall (106) and
   wherein the body side wall (106) is associated with the body side panel (102), and
   wherein the roof channel (120) comprises a vehicle bracket (130′), such as a fix-point vehicle bracket, for securing a roof rack (1) to the vehicle roof (100).
2. The vehicle roof (100) according to item 1, wherein the vehicle bracket (130′) comprises one or more protrusions (132) for an engagement member (3′) of the roof rack (1) to engage with, such as to hold around.
3. The vehicle roof (100) according to item 2, wherein the one or more protrusions are configured so that the engagement member (3′) of the roof rack (1) can engage with the one or more protrusions in a region of the roof channel (120) which is defined by the body side wall (106), the floor (104) and a vertical sectional plane (V) extending between an edge of the roof top panel (110) and the floor (104) of the roof channel (120), and also in a direction corresponding to a longitudinal extension of the body side wall (106).
4. The vehicle roof (100) according to any one of items 2 or 3, wherein the one or more protrusions (132) extend from the body side wall (106), and/or from the vertical sectional plane (V) extending between the edge of the roof top panel and the floor (104) of the roof channel (120), and also in a direction corresponding to a longitudinal extension of the body side wall (106), and/or the one or more protrusions extend between the body side wall (106) and the vertical sectional plane (V).
5. The vehicle roof (100) according to any one of items 2-4, wherein the one or more protrusions are T-shaped, mushroom shaped, eye-let shaped, and/or comprises cut-outs, so that the engagement member of the roof rack (1) can engage with the one or more protrusions.
6. The vehicle roof (100) according to any one of the preceding items, wherein the vehicle bracket (130′) is attached to the floor (104), and/or to the body side wall (106), and/or to a floor portion beneath the roof top panel (110).
7. The vehicle roof (100) according to item 6, wherein the vehicle bracket is inclined, such as L-shaped, as seen in a sectional plane which is perpendicular to a longitudinal extension of the roof channel (120), with one side attached to the floor and/or the floor portion beneath the roof top panel (110), and another side optionally attached to the body side wall (106).
8. The vehicle roof (100) according to any one of the preceding items, wherein the vehicle bracket is U-shaped, as seen in a sectional plane which is perpendicular to a longitudinal extension of the roof channel (120), such as U-shaped with one or more pin members extending across opposite side flanges of the U-shaped vehicle bracket.
9. The vehicle roof (100) according to any one of the preceding items, wherein a portion of the vehicle bracket which comprises means for securing the roof rack to the vehicle is provided substantially in parallel with the body side wall (106), as seen in a sectional plane which is perpendicular to a longitudinal extension of the roof channel (120), such as the portion is provided in parallel with and offset from the body side wall (106) so that a gap is formed between the portion and the body side wall (106), or in parallel and in connection with the body side wall (106) so that a gap is formed between the portion and the roof top panel (110).
10. The vehicle roof (100) according to any one of the preceding items, wherein the vehicle bracket is an integral portion of the body side panel (102),
11. The vehicle roof (100) according to item 10, wherein the vehicle bracket is formed as an overhang portion of the body side wall (106), and/or is hook-shaped, as seen in a sectional plane which is perpendicular to a longitudinal extension of the roof channel (120).
12. The vehicle roof (100) according to any one of the preceding items, wherein the roof top panel (110) is a glass roof panel.
13. The vehicle roof (100) according to any one of the preceding items, wherein the vehicle bracket is a sheet metal element, such as a bent sheet metal element.
14. The vehicle roof (100) according to any one of the preceding items, wherein the roof channel (120) has a channel opening width in the range of 5-20 mm, such as 5-15 mm or 5-10 mm.
15. The vehicle roof (100) according to any one of the preceding items, wherein the vehicle bracket is configured so that an engagement member of the roof rack can engage with the vehicle bracket by initially lowering the engagement member into the roof channel, followed by moving the engagement member in a substantially horizontal direction, such as in a longitudinal direction of the roof channel and/or in a width direction of the roof channel, so that it engages with the vehicle bracket, and/or by rotating the engagement member about an axis extending in the longitudinal extension of the roof channel so that it engages with the vehicle bracket.
16. The vehicle roof (100) according to item 15, wherein the width direction is a direction facing away from the roof top panel and towards the body side wall.

In the below, features and feature combinations of the fourth aspect of the disclosure are presented as a list of items:
1. A roof rack alignment tool (200) for aligning an engagement member (3) of a roof rack to a vehicle bracket (130) of a vehicle, the roof rack alignment tool (200) comprising:
   a first surface (202) for parallel alignment to a vehicle roof (100),
   a second surface (204) extending at an angle of substantially 90 degrees with respect to the first surface (202), wherein the second surface (204) is configured to extend into a roof channel (120) of the vehicle roof (100) during use.
2. The roof rack alignment tool (200) according to item 1, wherein the second surface (204) is a folded portion of the first surface (202).
3. The roof rack alignment tool (200) according to any one of the preceding items, wherein the second surface forms a cut-out (206) for receiving the engagement member (3) of the roof rack so that the engagement member (3) can engage with the vehicle bracket (130) of the vehicle therethrough.
4. The roof rack alignment tool (200) according to item 3, wherein the second surface (204) is formed by first and second leg portions (208, 210), wherein the cut-out (206) is formed in-between the first and second leg portions (208, 210).
5. The roof rack alignment tool (200) according to item 3 or 4, further comprising a visual alignment indicator (212) for a user, such as an arrow, wherein the visual alignment indicator (212) is associated with the cut-out (206), such as provided mid-way in-between the first and second leg portions (208, 210).
6. The roof rack alignment tool (200) according to any one of the preceding items, further comprising a third surface (216) for aligning the tool with the vehicle bracket (130) of the vehicle, wherein the third surface (216) extends from an outer edge of the second surface (204), such as the third surface (216) extends substantially in parallel with the vehicle roof (100) when the roof rack alignment tool (200) is in use.
7. The roof rack alignment tool (200) according to item 6, wherein the third surface (216) is a folded portion of the second surface (204).
8. The roof rack alignment tool (200) according to any one of items 6 or 7, wherein the third surface is formed by at least one auxiliary leg portion, such as the at least one auxiliary leg portion is an extension of the first or the second leg portion according to item 4.
9. The roof rack alignment tool (200) according to item 8, wherein the third surface is formed by two auxiliary leg portions, each auxiliary leg portion being an extension of the respective first and second leg portions according to item 4.
10. The roof rack alignment tool (200) according to any one of items 6-9, wherein the first, second and third surfaces form a substantially U-shaped tool or a substantially step-shaped tool, as seen in sectional plane defined by a longitudinal extension and a height extension of the tool.
11. The roof rack alignment tool (200) according to any one of the preceding items, wherein the roof rack alignment tool (200) is configured so that it can be moved in a longitudinal direction of the roof channel (120) until it reaches the vehicle bracket (130) of the vehicle, such as until the third surface (216) according to any one of items 6-10 reaches the vehicle bracket (130) of the vehicle.
12. The roof rack alignment tool (200) according to any one of the preceding items, further comprising a fourth surface (218) for a user to grip on, wherein the fourth surface extends from an outer edge of the first surface (202), such as at an angle of substantially 90 degrees with respect to the first surface (202), and wherein the fourth surface is provided on an opposite side of the roof rack alignment tool (200) with respect to the second surface (202).
13. The roof rack alignment tool (200) according to item 12, wherein the fourth surface (218) is extending around a corner of the first surface (202) to increase the rigidity of the fourth surface (218) and/or of the first surface (202).
14. The roof rack alignment tool (200) according to any one of items 12 or 13, wherein the fourth surface (218) forms a cut-out (220) for a user to grip in.

In the below, features and feature combinations of the fifth aspect of the disclosure are presented as a list of items:
1. A roof rack (1) for a vehicle, comprising:
   a cross bar member (5) for carrying a load on the vehicle, wherein the cross bar member (5) comprises a longitudinally extending cross bar channel (52),
   an end cap (300) for the cross bar member (5), wherein the end cap (300) comprises a cover (302) for covering an end portion of the cross bar channel (5), and wherein the cross bar channel comprises cover engaging flanges (54) for engaging with an engaging portion (304) of the cover (302) when the end cap is mounted to the cross bar member (5).
2. The roof rack (1) according to item 1, wherein the cover engaging flanges (54) extend in a longitudinal direction (L) of the cross bar channel (5).
3. The roof rack (1) according to any one of the preceding items, wherein the cover engaging flanges (54) and the engaging portion (304) of the cover (302) are configured to allow longitudinal sliding movement of the cover (302) in the cross bar channel (52) and to prevent movement of the cover (302) in an upward direction (h) from the cross bar channel (52).
4. The roof rack (1) according to any one of the preceding items, wherein the end portion of the cross bar channel (5) comprises a tightening tool engaging portion (46) for tightening and releasing the roof rack (1) to/from the vehicle by use of a tightening tool, wherein the cover (302) is adapted for preventing unauthorized access to the tightening tool engaging portion (46).
5. The roof rack (1) according to any one of the preceding items, wherein, when the end cap (300) is mounted to the cross bar member (5), the cover (302) is substantially flush with an outer surface of the cross bar member (5).
6. The roof rack (1) according to any one of the preceding items, wherein the engaging portion (304) of the cover (302) is T-shaped, as seen in a sectional plane being perpendicular to a longitudinal extension (L) of the end cap and the cross bar member (5).
7. The roof rack (1) according to any one of the preceding items, wherein the engaging portion (304) of the cover (302) is provided at a longitudinally outer end of the cover (302).
8. The roof rack (1) according to any one of the preceding items, wherein the end cap (300) comprises a lock cylinder (306) for locking the end cap (300) to the cross bar member (5).
9. An end cap (300) for a roof rack cross bar member (5) of a roof rack (1), comprising:
   a cover (302) for covering an end portion of a cross bar channel (52), wherein the cover comprises an engaging portion (304) for engaging with cover engaging flanges (54) of the cross bar channel (52) when the end cap (300) is mounted to the cross bar member (5).
10. The end cap according to item 9, wherein the engaging portion (304) of the cover (302) is T-shaped, as seen in a sectional plane being perpendicular to a longitudinal extension of the end cap (300), corresponding to a longitudinal extension of the cross bar member (5) when the end cap is mounted to the cross bar member (5).
11. The end cap (300) according to any one of items 9 or 10, wherein the engaging portion (304) of the cover (302) is provided at a longitudinally outer end of the cover (302).
12. The end cap (300) according to any one of items 9-11, further comprising a lock cylinder (306) for locking the end cap (300) to the cross bar member (5).
13. The end cap (300) or roof rack (1) according to any one of the preceding items, wherein the cover (302) has a length of 20-200 mm, such as 40-150 mm or 40-100 mm.

### BRIEF DESCRIPTION OF THE DRAWINGS

With reference to the appended drawings, below follows a more detailed description of embodiments of the disclosure cited as examples.

In the drawings:

FIGS. 1a-b show sectional views of a roof rack according to an example embodiment of the present disclosure,

FIG. 1c shows a perspective view of a roof rack according to an example embodiment of the present disclosure,

FIG. 1d shows a perspective view of a roof rack according to an example embodiment of the present disclosure where certain parts have been omitted to better illustrate certain features of the roof rack,

FIGS. 2a-d show perspective views of an engagement member according to example embodiments of the present disclosure,

FIGS. 2e-f show sectional views of an engagement member according to example embodiments of the present disclosure,

FIGS. 2g-h show sectional views of an engagement member and a vehicle bracket according to example embodiments of the present disclosure,

FIG. 2i shows a perspective view of an engagement member and a vehicle bracket according to an example embodiment of the present disclosure,

FIG. 3 shows a flowchart of a mounting method according to an example embodiment of the present disclosure,

FIG. 4a shows a side view of a roof rack and a vehicle roof according to an example embodiment of the present disclosure,

FIGS. 4b-c show perspective views of a vehicle bracket and an engagement member according to example embodiments of the present disclosure,

FIG. 5 shows a side view of a roof rack and a vehicle roof according to an example embodiment of the present disclosure,

FIG. 6a shows a perspective view of a roof rack and a vehicle roof according to an example embodiment of the present disclosure,

FIG. 6b shows a side view of the roof rack and vehicle roof as shown in FIG. 6a,

FIG. 6c shows a perspective view of an engagement member as also shown in FIGS. 6a-b,

FIG. 7a shows a side view of a roof rack and a vehicle roof according to an example embodiment of the present disclosure,

FIGS. 7b-c show perspective views of an engagement member as also shown in FIG. 7a,

FIG. 8 shows a side view of a roof rack and a vehicle roof according to an example embodiment of the present disclosure,

FIGS. 9a-b show perspective views of a roof rack alignment tool according to an example embodiment of the present disclosure,

FIGS. 10a-d show schematic side views of roof rack alignment tools according to example embodiments of the present disclosure,

FIGS. 11a-b show perspective views of a roof rack according to an example embodiment of the present disclosure,

FIG. 11c shows a side view of a roof rack as shown in FIG. 11b,

FIG. 11d shows a schematic view of an end cap and cover engaging flanges of a cross bar channel according to an example embodiment of the present disclosure, and

FIGS. 12a-c show perspective views of a roof rack alignment tool according to an example embodiment of the present disclosure.

The drawings show diagrammatic exemplifying embodiments of the present disclosure and are thus not necessarily drawn to scale. It shall be understood that the embodiments shown and described are exemplifying and that the disclosure is not limited to these embodiments. It shall also be noted that some details in the drawings may be exaggerated in order to better describe and illustrate the disclosure. Like reference characters refer to like elements throughout the description, unless expressed otherwise.

### DETAILED DESCRIPTION OF EXAMPLE EMBODIMENTS OF THE DISCLOSURE

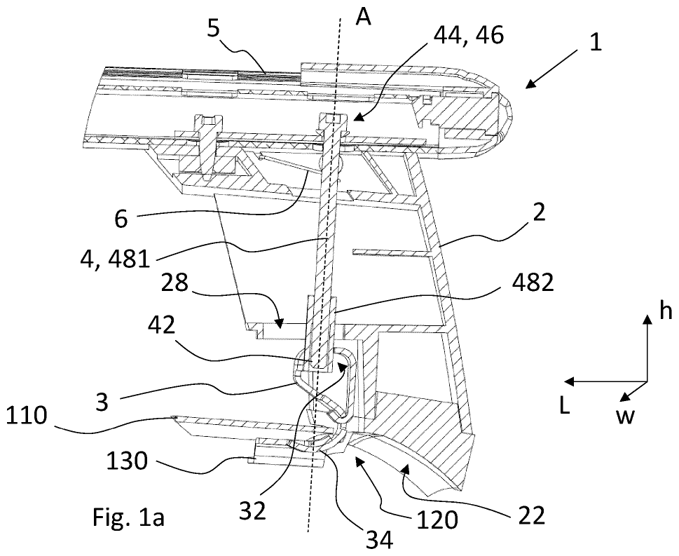

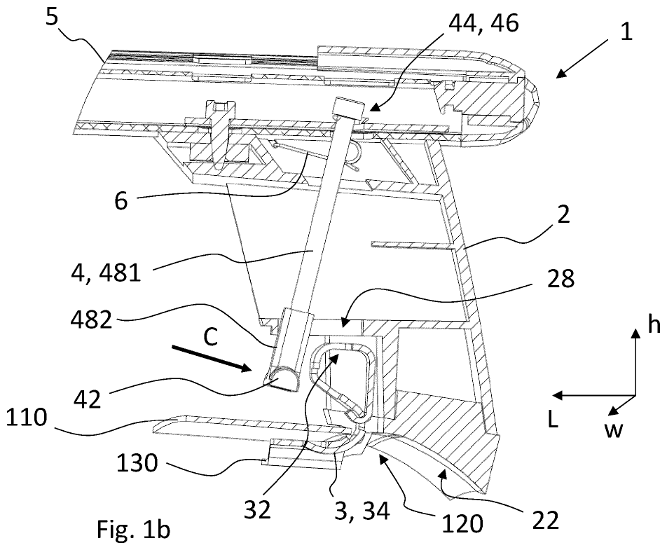

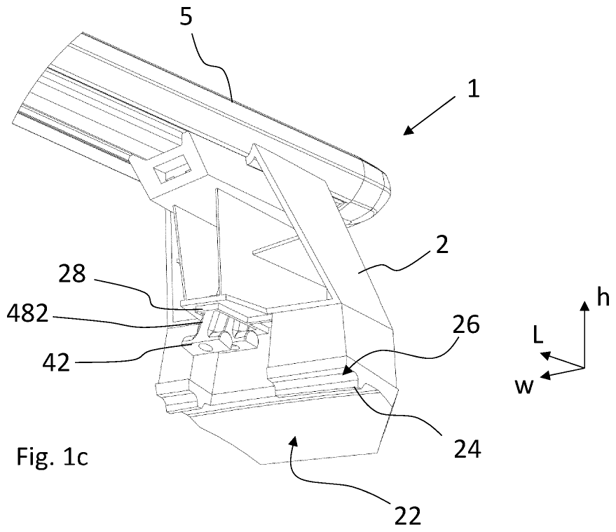

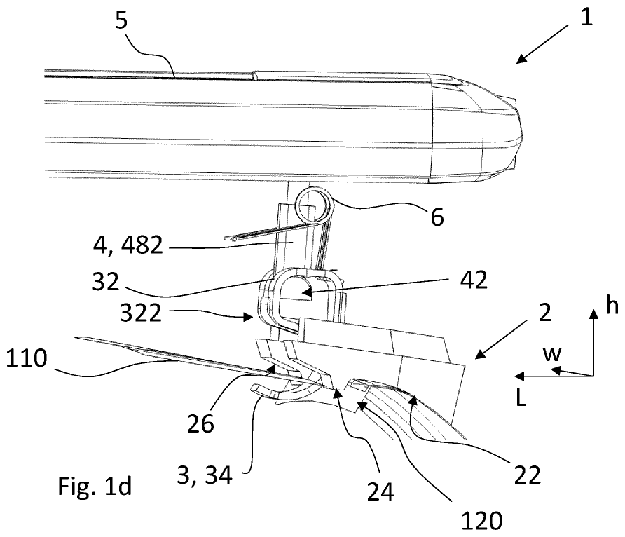

FIGS. 1a and 1b depict sectional views of a roof rack 1 for a vehicle (not shown) according to an example embodiment of the present disclosure. The roof rack 1 has a width extension w, a height extension h and a longitudinal extension L. The sectional view, or cross-section, is a plane defined by the longitudinal extension L and the height extension h. The width extension w corresponds to a longitudinal extension of the vehicle.

The roof rack 1 comprises:
a roof rack foot member 2 comprising a vehicle roof support surface 22. Accordingly, the vehicle roof support surface 22 is intended to be supported by a surface of the vehicle (not shown), such as a body side panel of the vehicle.

The roof rack 1 further comprises:
an engagement member 3 for engaging with a vehicle bracket 130 of the vehicle,
a tightening member 4 for tightening the engagement member 3, and
a cross bar member 5 for carrying a load on the vehicle.

The tightening member 4 is coupled to the roof rack foot member 2 and the cross bar member 5 for securing the roof rack 1 to the vehicle.

As shown, the longitudinal extension L of the roof rack 1 corresponds to a longitudinal extension of the cross bar member 5.

Furthermore, the tightening member 4 comprises a first engagement section 42 and the engagement member 3 comprises a second engagement section 32, which first and second engagement sections 42, 32 are connectable and correspondingly configured for tightening the engagement member 3 with respect to the vehicle bracket 130.

In FIG. 1a, the first engagement section 42 is connected to the second engagement section 32, whereas in FIG. 1b, the first engagement section 42 is disconnected from the second engagement section 32.

The first engagement section 42 is as shown in e.g. FIG. 1b connectable to the second engagement section 32 in a first connection direction C (indicated by an arrow) which is different from the height extension h. More particularly, in the shown embodiment, the first connection direction C corresponds to the longitudinal extension L of the roof rack 1. More precisely, as shown, the first connection direction C may be directed away, in the longitudinal extension L, from a second roof rack foot member (not shown) which is provided on an opposite side of the cross bar member 5. Accordingly, when disconnecting the tightening member 4 from the engagement member 3, a disconnection direction will be directed in an opposite direction to the first direction C.

The engagement member 3 as shown comprises an engaging portion 34 for engaging with the vehicle bracket 130 of the vehicle and the tightening member 4 comprises a cross bar engaging portion 44 for engaging with the cross bar member 5. As shown in FIG. 1a, the tightening member 4 may be configured to transfer forces along a substantially straight line A from the engaging portion 34 to the cross bar engaging portion 44. Thereby, unwanted bending moments exerted at the engaging portion 34 can be mitigated.

As depicted in e.g. FIGS. 1a-b, the tightening member 4 may be a screw member. Accordingly, as shown, the tightening member 4 may comprise a tightening tool engaging portion 46, which herein is a screw head. Thereby, a tightening tool (not shown) may be inserted from above through an opening of the cross bar member 5, such as through as a cross bar channel, to tighten the tightening member 4 with respect to the engagement member 3. Accordingly, the tightening member 4 may as shown be a rod-formed tightening member for tightening the engagement member 3 to the vehicle bracket 130. The rod-formed tightening member as disclosed herein may not only be a screw member. For example, the rod-formed tightening member may be configured to apply a tightening force to the engagement member 3 by pulling in the rod-formed tightening member in its longitudinal direction, e.g., without rotating the rod-formed tightening member.

As further depicted e.g. in FIGS. 1a-b, the roof rack 1 may further comprise a biasing member 6 for biasing the tightening member 4 towards a disconnected state, i.e. as shown in FIG. 1b, with respect to the engagement member 3. In the shown example, the biasing member 6 is a spring-biased member, and more specifically a torsion spring which biases the tightening member 4. The biasing member 6 is mechanically connected to the cross bar member 5 and the roof rack foot member 2.

The roof rack foot member 2 may comprises a guide surface 28 for the tightening member 4, such as a guide slot 28, which is adapted to align the first engagement section 42 with respect to the second engagement section 32 and/or adapted to accommodate forces exerted on the tightening member 4 which are directed in directions different from a longitudinal extension of the tightening member 4. As shown, the tightening member 4 may be guided in the guide slot 28 in the longitudinal extension L between its connected and disconnected state with respect to the engagement member 3. The guide slot 28 is also depicted in FIG. 1c, which shows the roof rack 1 with the roof rack foot member 2 in a perspective view from below.

For example, as may be gleaned in FIGS. 1a-b, the first engagement section 42 may be connectable to the second engagement section 32 by pivoting the tightening member 4, such as the rod-formed tightening member, about an axis which is substantially perpendicular to a longitudinal extension of the tightening member 4. For example, as shown, the tightening member 4 may be pivotable about an axis which extends along the width extension w of the roof rack. As further shown, the tightening member 4 may be configured to be disconnected from the engagement member 3 by pivoting the tightening member 4 in a direction towards a second roof rack foot member (not shown) which is provided on an opposite side of the cross bar member 5, as seen in a direction corresponding to the longitudinal extension L of the cross bar member 5. Accordingly, as also shown, the tightening member 4 may be configured to be connected to the engagement member 3 by pivoting the tightening member 4 in a direction away from the second roof rack foot member. The pivot axis for pivoting the tightening member 4 may as shown be provided at or proximate an interface between the cross bar member 5 and the roof rack foot member 2.

As further depicted in e.g. FIGS. 1a-b, the vehicle roof support surface 22 is preferably adapted to only rest on a vehicle roof surface of the vehicle which is provided on one side with respect to the vehicle bracket 130, as seen in a direction corresponding to the longitudinal extension L of the cross bar member 5. More preferably, the tightening member 4 is coupled to the roof rack foot member 2 and the cross bar member 5 so that the roof rack foot member 2 is prevented from inclining inwards towards the vehicle when the tightening member 4 is tightening the engagement member 3 with respect to the vehicle bracket 130.

In the shown embodiment, the roof rack foot member 2 is configured to avoid contact with an adjacent glass roof panel 110 of the vehicle when the roof rack 1 is mounted on the vehicle. This may e.g. be accomplished by configuring the roof rack foot member 2 with an additional surface 26 which faces the glass roof panel 110 and which is raised with respect to the vehicle roof support surface 22. In other words, when the vehicle roof support surface 22 rests on the vehicle roof, a free space is formed between the additional surface 26 and the glass roof panel 110, as e.g. shown in FIG. 1d. FIG. 1d shows the roof rack 1 where certain elements of the roof rack foot member 2 have been omitted to better illustrate the other features of the roof rack 1 as described herein.

As further depicted in FIG. 1d, the roof rack foot member 2 may comprise an alignment portion 24 for aligning the roof rack foot member 2 with a roof channel 120 of the vehicle. The vehicle bracket 130 is preferably provided in the roof channel 120 of the vehicle. The alignment portion 24 may for example define an intersection between the above-mentioned vehicle roof support surface 22 and the additional surface 26. The alignment portion 24 is preferably configured to extend into the roof channel 120 when the roof rack foot member 2 is mounted to the vehicle. As shown, the alignment portion 24 preferably has a main extension in the width extension w, and is further configured to prevent movement in the longitudinal extension L when it is provided in the roof channel 120. Thereby, a user can more easily position the roof rack foot member 2 on the vehicle during mounting of the roof rack 1.

With reference to e.g. FIGS. 1a and 1b, the first engagement section 42 is further preferably connectable to the second engagement section 32 in a second connection direction which corresponds to the longitudinal extension of the tightening member 4. Accordingly, when the first engagement section 42 has been inserted into the second engagement section 32 as shown in FIG. 1a, the first engagement section 42 will be moved upwardly towards the cross bar member 5 when the tightening member 4 is tightened.

Furthermore, the tightening member 4 and the guide surface 28, as seen in a sectional plane being perpendicular to a longitudinal extension of the tightening member 4, may as shown be formed to prevent any rotational movement of the tightening member 4 about the longitudinal extension of the tightening member 4. Thereby, a more robust connection can be provided, preventing the tightening member 4 from rotating with respect to the roof rack foot member 2. In the embodiment shown in e.g. FIGS. 1b and 1c, the tightening member 4 is square-formed at the guide surface 28, thereby preventing any rotation therebetween about the longitudinal extension of the tightening member 4. The square-form is seen in a plane being perpendicular to the longitudinal extension of the tightening member 4.

As depicted in e.g. FIGS. 1a-d, the tightening member 4 may comprise at least two separate parts. A first part in the form of a screw 481 and a second part 482, which here is T-shaped, forming the first engagement section 42. The second part 482 may in an embodiment be denoted a nut member, such as a T-formed nut member. The screw 481 is insertable into a threaded hole of the second part 482. Accordingly, the tightening member 4 can be tightened with respect to the engagement member 3 by screwing the screw 481 further into the hole of the second part 482.

As further depicted in e.g. FIGS. 1a-d, the first and second engagement sections 42, 32 are correspondingly configured by respective curved surfaces which are at least partly matching surfaces. More precisely, as shown, the second part 482 of the tightening member 4 may comprise a convexly shaped curved surface which at least partly matches with a corresponding concavely shaped surface of the second engagement section 32 of the engagement member 3. By having such matching surfaces, forces can be transferred therebetween in a more predicted manner, thereby avoiding e.g. any unwanted bending moments.

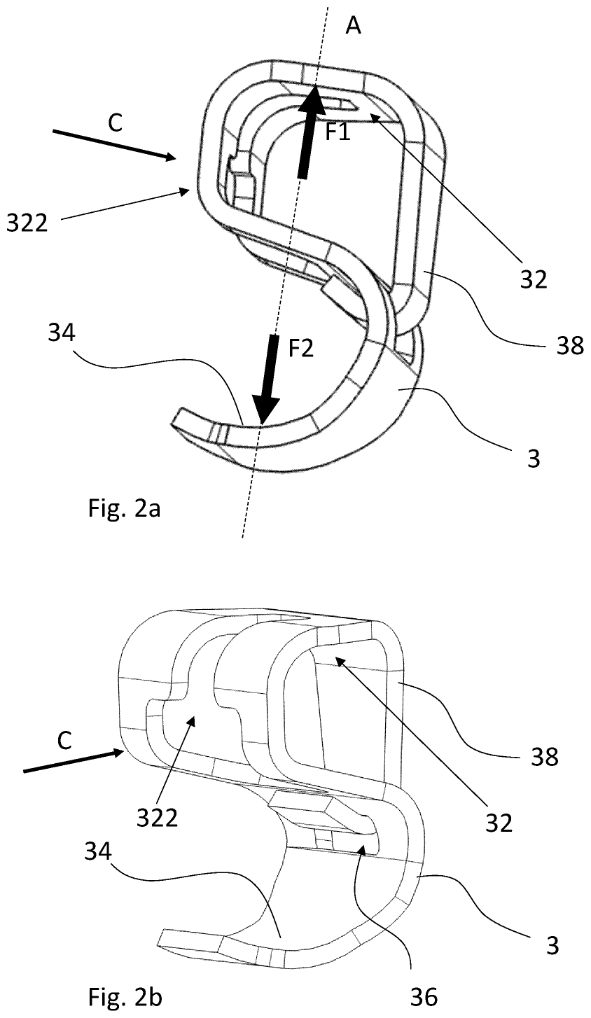

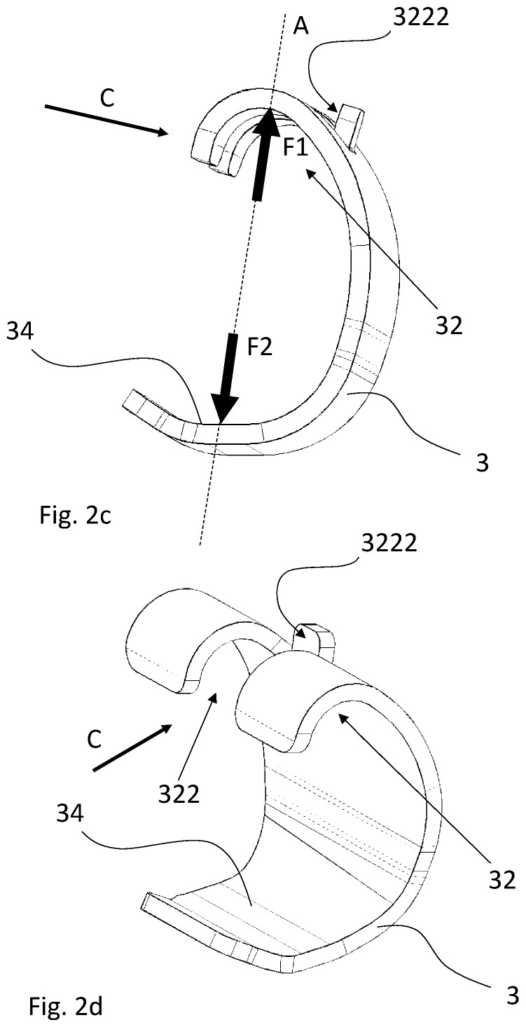

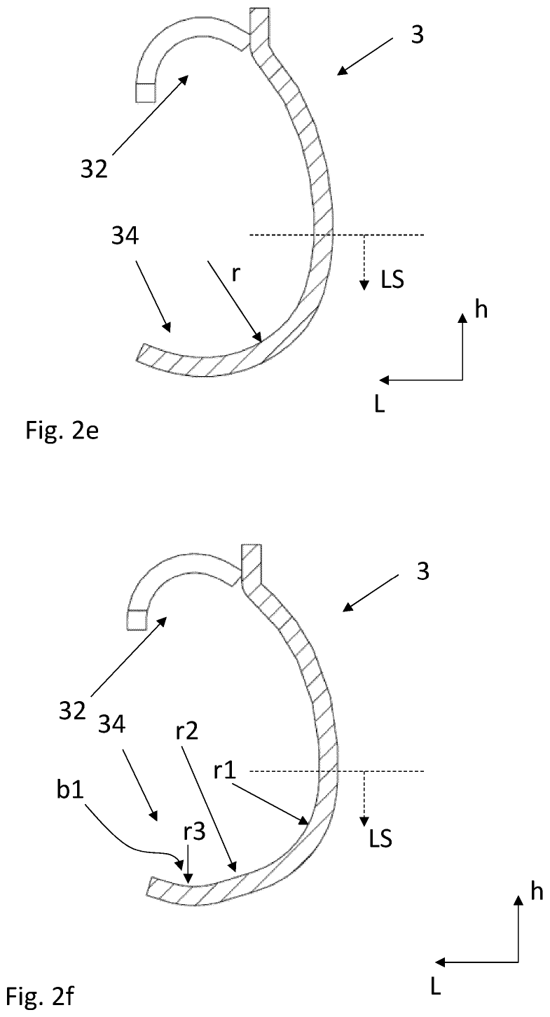

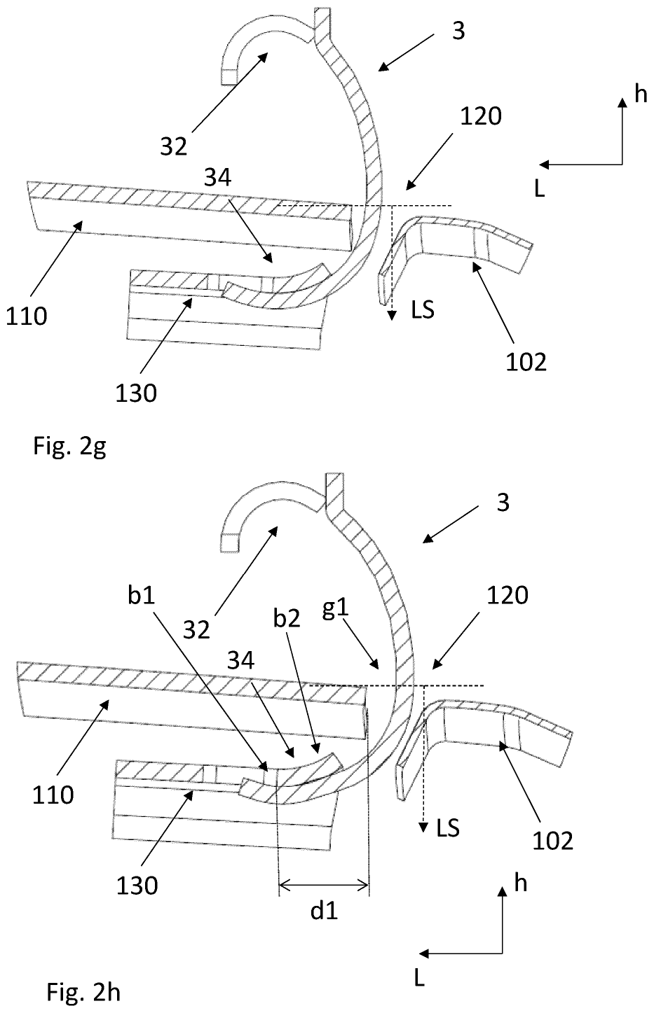

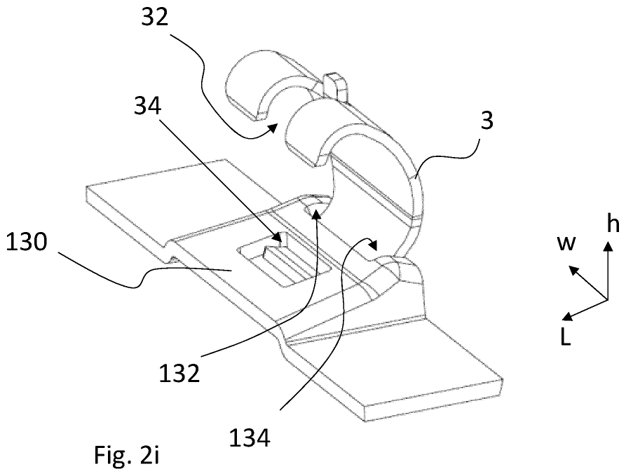

With reference to FIGS. 2a-b, a more detailed perspective view of an engagement member 3 according to an example embodiment of the disclosure is shown. The engagement member 3 in FIGS. 2a-b corresponds to the engagement member 3 as shown in FIGS. 1a-d.

More specifically, as may be gleaned in FIG. 2a, the first engagement section 42 (not shown) is configured for tightening the engagement member 3 with respect to the vehicle bracket 130 by application of a first tightening force F1 exerted on the second engagement section 32. The engagement member 3 comprises as shown an engaging portion 34 for engaging with the vehicle bracket 130 of the vehicle and the tightening member 4 (not shown) is configured for tightening the engaging portion 34 with respect to the vehicle bracket 130 so that a second tightening force F2 is exerted on the engaging portion 34 by the vehicle bracket 130. The engagement member 3 is configured so that the second tightening force F2 and the first tightening force F1 are substantially aligned. As shown, the first and second forces F1 and F2 are provided along the line A as also depicted in FIG. 1a.

The tightening member 4 has a main extension in a longitudinal direction thereof, in this example in a direction along the height extension h. For example, as may be gleaned in FIGS. 1a and 2a, the rod-formed tightening member 4 and the engagement member 3 may be configured such that the second tightening force F2 and the first tightening force F1 are substantially aligned with a centre axis A of the rod-formed tightening member 4 which extends in the longitudinal direction of the rod-formed tightening member 4.

This configuration may for example be accomplished in that the second engagement section 32 comprises an opening 322, such as a slot 322, for receiving the first engagement section 42 in the first connection direction C, see FIG. 2b. The opening faces in a direction which corresponds to the longitudinal extension L of the cross bar 5, in this example in a direction towards a second roof rack foot member (not shown) provided on an opposite side of the cross bar member 5, as seen in the longitudinal extension L.

In the shown embodiment, the opening 322 is formed so that it can receive the above-mentioned T-formed part 482, i.e. the first engagement section 42. More particularly, in the shown embodiment, the opening 322 has a corresponding T-shape. In alternative embodiments, the first engagement section 42 may e.g. be L-formed, J-formed, or ball-formed. Accordingly, the opening 322 of the second engagement section 32 may be formed in a corresponding manner for receiving the first engagement section 42.

The engagement member 3 may as shown in FIGS. 2a-b be a hook member. Accordingly, the engaging portion 34 is hook-formed for engagement with the vehicle bracket 130.

Preferably, the engagement member 3 is detachable from the roof rack 1. More particularly, when the tightening member 4 is disconnected from the engagement member 3, it is also completely disconnected from the roof rack 1. This allows the engagement member 3 to first be inserted in the roof channel 120 to engage with the vehicle bracket 130, whereafter the roof rack foot member 2 is mounted onto the vehicle roof. The insertion of the engagement member 3 may be performed by rotating the engagement member 3 with respect to the width extension w, corresponding to the longitudinal extension of the vehicle.

As further depicted in FIGS. 2a-b, the engagement member 3 may be a bent sheet-metal element, such as the second engagement section 32 is formed by bent sheet-metal, for example bent to hook into a slot 36 formed in itself, the engagement member 3 is bent to form an open hook end 34, and/or it is bent to form a closed loop end 38. Accordingly, the closed loop end 38 may form a space in which the first engagement section 42 can be received. For example, as shown in FIGS. 2a-b, the engagement member 3 may be formed as the number 9.

With reference to FIGS. 2c-d, the engagement member 3 may alternatively as shown be a hook member which is C-formed. As such, for example, and as shown in FIGS. 2c-d, the C-formed engagement member 3 may comprise a second engagement section 32 as disclosed herein, and further comprise an engaging portion 34 as disclosed herein for engaging with the vehicle bracket 130 of the vehicle. As shown, the C-formed engagement member 3 may be configured, e.g., by bent sheet metal, such that the engaging portion 34 is formed as an open hook end 34, and such that the second engagement section 32 is formed as an open hook end 32, wherein the open hook ends 32, 34 are facing each other.

Similar to the example shown in FIGS. 2a-b, the second engagement section 32 of the C-formed engagement member 2 may as shown comprise an opening 322, such as a slot 322, for receiving the first engagement section 42 in the first connection direction C, see FIG. 2d. The opening 322 faces in a direction which corresponds to the longitudinal extension L of the cross bar 5, in this example in a direction towards a second roof rack foot member (not shown) provided on an opposite side of the cross bar member 5, as seen in the longitudinal extension L.

In the embodiment shown in FIG. 2d, the opening 322 is formed so that it can receive the above-mentioned T-formed part 482, i.e., the first engagement section 42. In alternative embodiments, the first engagement section 42 may e.g. be L-formed, J-formed, or ball-formed. Accordingly, the opening 322 of the second engagement section 32 may be formed in a corresponding manner for receiving the first engagement section 42, if required.

For example, as may further be gleaned in FIGS. 2a-d, the opening 322, e.g., the slot 322, may be configured such that it prevents a relative rotation between the tightening member 4 and the engagement member 3 about an axis A which extends in a longitudinal extension of the tightening member 4.

For example, the tightening member 4 may be square-formed at the opening 322, thereby preventing any rotation about the axis A. The square-form is seen in a plane being perpendicular to the longitudinal extension of the tightening member 4. Accordingly, the opening 322, e.g., the slot 322, may comprise corresponding guide surfaces for preventing any rotation about the axis A. In the example shown in FIGS. 2c-d, a guide surface 3222 for preventing a rotation about the axis A is provided at an end portion of the opening 322. As may be gleaned, the guide surface 3222 may be formed as a planar surface adapted to face a corresponding planar surface of the tightening member 4 when the tightening member 4 is provided in the opening 322.

The engagement member 3 shown in FIGS. 2c-d is also preferably detachable from the roof rack 1. More particularly, when the tightening member 4 is disconnected from the engagement member 3, it is also completely disconnected from the roof rack 1. This allows the C-formed engagement member 3 to first be inserted in the roof channel 120 to engage with the vehicle bracket 130, whereafter the roof rack foot member 2 is mounted onto the vehicle roof. The insertion of the C-formed engagement member 3 may be performed by rotating the engagement member 3 with respect to the width extension w, corresponding to the longitudinal extension of the vehicle.

Similar to the example shown in FIGS. 2a-b, the first engagement section 42 (not shown) is configured for tightening the C-formed engagement member 3 with respect to the vehicle bracket 130 by application of a first tightening force F1 exerted on the second engagement section 32. The tightening member 4 (not shown) is configured for tightening the engaging portion 34 with respect to the vehicle bracket 130 so that a second tightening force F2 is exerted on the engaging portion 34 by the vehicle bracket 130. The engagement member 3 shown in FIGS. 2c-d is configured so that the second tightening force F2 and the first tightening force F1 are substantially aligned. As shown, the first and second forces F1 and F2 may also be provided along the line A as also depicted in FIG. 1a, i.e. along the centre axis A of the tightening member 4. Thereby, the risk unwanted bending moments can be mitigated.

FIGS. 2e-f show sectional views of engagement members 3 according to example embodiments of the disclosure. In this case C-formed engagement members 3, e.g., similar as described in the above. The engagement members 3 are also shown in FIGS. 2g-h, respectively, but when they are in engagement with a vehicle bracket 130 of a vehicle as disclosed herein. As may be gleaned in e.g., FIGS. 2e and 2g, the open hook end 34 of the hook-shaped engagement member 3, which may be part of or correspond to a lower section LS of the engagement member 3, may be bent along its extension with a substantially uniform curvature with a radius r. The lower section LS may be defined as the section which is intended to be inside the roof channel 120 when the engagement member 3 is in engagement with the vehicle bracket 130. In other words, the open hook end 34 and/or the lower section LS may be of, or at least substantially correspond to, a semi-circular shape. This shape may facilitate insertion, removal and/or rotation of the engagement member 3.

Alternatively, as may be gleaned in FIGS. 2f and 2h, the open hook end 34 of the hook-shaped engagement member 3 and/or the lower section LS of the engagement member 3, may be bent along its extension such that it has at least two different curvatures, e.g., with at least two different radii r1, r2, r3, along its extension. Thereby, as depicted in FIG. 2h, a relatively large gap g1 to the roof top panel 110 may be enabled while still the engaging portion 34 can engage with the vehicle bracket 130 at a position which is located at least a specific distance d1 under the roof top panel 110 away from the roof channel 120, as seen in the longitudinal extension L. This configuration of the engagement member 3 implies a robust connection to the vehicle while reducing the risk of damaging the roof top panel 110, e.g., a glass roof.

For example, as depicted in FIGS. 2f and 2h, the final end of the open hook end 34 may have a distinct bend b1 at the location where the engaging portion 34 is intended to engage with the vehicle bracket 130. Thereby, an improved/more robust engagement with the vehicle bracket 130 may be achieved. This may also imply that it may be easier for a user to find the right position of the engagement member 3 with respect to the vehicle bracket 130 during mounting. A distinct bend may be defined as a distinct change in the curvature, e.g., such that a noticeable trough portion is provided.

It shall be noted that the above mentioned configurations of the lower section LS of the C-shaped engagement member 3 may also be applicable to any other hook-shaped engagement member 3 as e.g. disclosed herein.

As may be gleaned in e.g. FIG. 2h, the vehicle bracket 130 as disclosed herein may have a hook end with a distinct bend b2 which is proximate the roof channel 120. As shown, the distinct bend b2 may be bent upwardly towards the roof top panel 110, thereby facilitating insertion of the engagement member 3. This may imply a reduced risk of damaging the roof top panel 110, e.g. the glass roof. For example, the vehicle bracket 130 as disclosed herein may be configured/dimensioned/positioned, e.g. bent or formed, so that the distance between the vehicle bracket 130 and the roof top panel 110 is small enough to prevent the engagement member 3 from entering this gap. For example, the gap may be 10 mm or less, such as 5 mm or less, as seen in the height extension h. Thereby, the risk of a user damaging the roof top panel 110 when inserting the engagement member 3 into the roof channel 120 may be mitigated.

With reference to FIG. 2i, a perspective view of an engagement member 3 and a vehicle bracket 130 according to the disclosure is depicted. The engagement member 3 is in this example C-shaped, even though also other shapes are conceivable. As may be gleaned, the vehicle bracket 130 as disclosed herein may comprise a forward support and/or guide portion 132 and/or a rearward support and/or guide portion 134 for the engagement member 3, as seen along the longitudinal extension of the vehicle, corresponding to the width extension w of the roof rack 1. For example, the forward support and/or guide portion 132 and/or the rearward support and/or guide portion 134 may be arranged to prevent a rotation of the engagement member 3 about an axis extending in the longitudinal extension L of the roof rack 1. This implies a safer and more robust connection, e.g., improved accommodation of forces during rapid braking and/or collisions. Additionally, or alternatively, the forward support and/or guide portion 132 and/or the rearward support and/or guide portion 134 may be arranged to guide the engagement member 3 when it is rotated into its engagement position. This implies facilitated mounting of the roof rack 1 for a user. For example, the forward support and/or guide portion 132 and/or the rearward support and/or guide portion 134 may be arranged, such as bent, to create a tapered lead-in portion and/or the engagement member 3 may have a corresponding tapered shape, to thereby facilitate entry of the engagement member 3 by co-operating guide surfaces.

As a yet further example, not shown, the vehicle bracket 130 may comprise an extended flange or elongated bend on either or both sides thereof arranged to prevent the engagement member 3 from being inserted at a wrong location along the roof channel 120. Thereby, the risk of damaging e.g. the glass roof may be mitigated. For example, the extended flange or elongated bend may extend along the full length of the glass portion of the vehicle roof, except at the engagement locations.

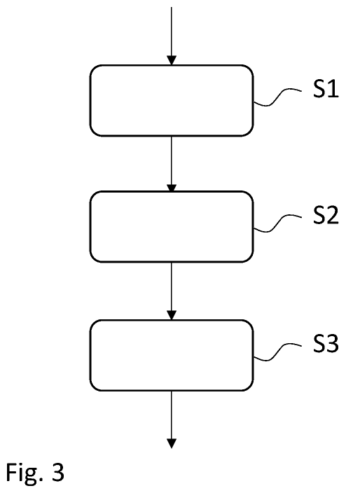

With reference to FIG. 3, a flowchart of a mounting method for mounting a roof rack 1 to a vehicle according to an example embodiment of the present disclosure is shown. The roof rack 1 is a roof rack 1 according to any one of the embodiments of the first aspect of the disclosure.

The method comprises:

S1: aligning and positioning the engagement member 3 with respect to the vehicle bracket 130. This may for example be achieved by inserting the engagement member 3 into the roof channel 120, and also rotating the engagement member 3 about an axis extending in the width extension w. Further, this may also be done by use of a roof rack alignment tool 200 as disclosed herein. In the embodiment shown in FIGS. 1a-d, the engagement member 3 is rotated in a clockwise direction until it reaches its final position where the engaging portion 34 contacts the vehicle bracket 130.

The method further comprises:

S2: positioning the roof rack foot member 2 with the vehicle roof support surface 22 onto the vehicle so that the tightening member 4 is aligned with the engagement member 3. For example, this is shown in FIGS. 1b and 1a. In other words, the roof rack foot member 2 is first positioned on the vehicle, whereafter the first engagement section 42 is inserted into the second engagement section 32 in the first connection direction C.

The method further comprises:

S3: tightening the engagement member 3 by use of the tightening member 4. For example, this may be done as mentioned in the above where a tightening tool is rotating the first part 481 of the tightening member 4. The tightening tool may for example be a screwdriver which is inserted from above through an opening of the cross bar member 5 for engaging with the tightening tool engaging portion 46. Alternatively, a tightening tool (not shown) may be used for pulling in the tightening member without rotating the tightening member, or a tightening tool may be used for pulling in the tightening member and for rotating the tightening member to thereby tighten the engagement member to the vehicle bracket 130.

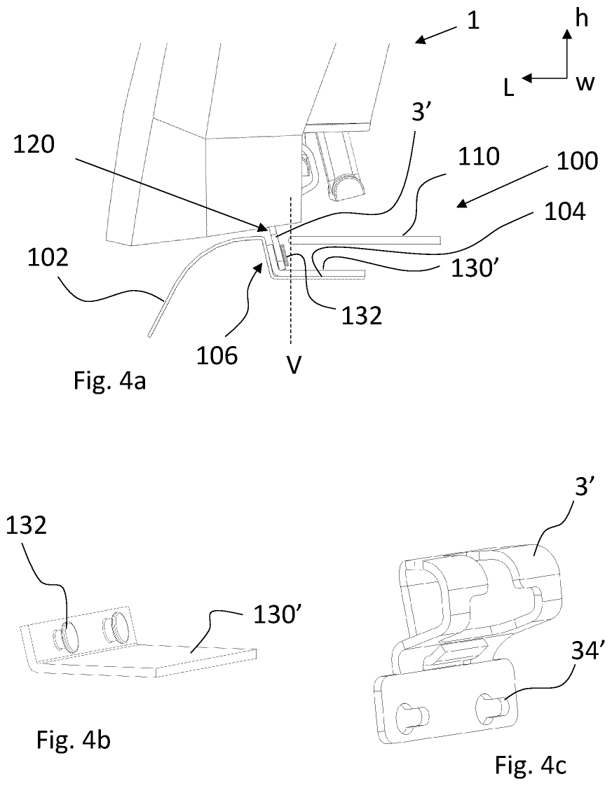

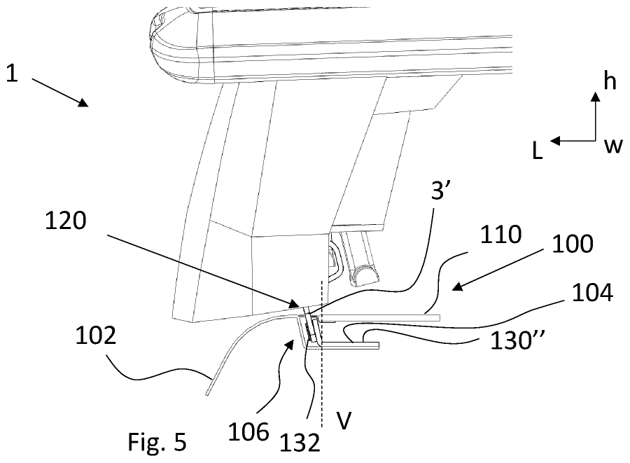

With reference to FIGS. 4a-c, an alternative embodiment of a roof rack 1 is shown, and also a vehicle roof 100 according to an example embodiment of the third aspect of the disclosure. Further alternative embodiments of the roof rack 1 and vehicle roof 100 are shown in FIGS. 5-8.

The vehicle roof 100 is shown in a cross-sectional view which is perpendicular to a longitudinal extension of the vehicle. Accordingly, the width direction w of the roof rack corresponds to the longitudinal extension of the vehicle.

The vehicle roof 100 comprises a body side panel 102, a roof top panel 110 and a roof channel 120, wherein the roof channel 120 defines an intersection between the body side panel 102 and the roof top panel 110.

The body side panel 102 is typically provided above a vehicle door (not shown).

The roof channel 120 comprises a floor 104 and a body side wall 106. The body side wall 106 is associated with the body side panel 102. In these shown embodiments, the body side wall 106 is part of the body side panel 102. As further shown, the body side wall 106 typically faces the roof top panel 110.

The roof channel 120 comprises a vehicle bracket 130′, which in FIG. 4a is a fix-point vehicle bracket, for securing the roof rack 1 to the vehicle roof 100.

The roof rack 1 may be configured as mentioned herein. Depending on the type of vehicle bracket, the configuration of an engagement member 3-3′″ of the roof rack 1 may be altered. Accordingly, the disclosure comprises several different configurations of the engagement member 3-3′″ adapted to match with different types of vehicle brackets 130-130″″.

The vehicle bracket 130′ as shown in FIGS. 4a-b comprises one or more protrusions 132 for an engagement member 3′ of the roof rack 1 to engage with. In the shown embodiment, the engagement member 3′ of the roof rack 1 holds around the one or more protrusions 132.

As further shown, the one or more protrusions 132 may be configured so that the engagement member 3′ of the roof rack 1 can engage with the one or more protrusions 132 in a region of the roof channel 120 which is defined by the body side wall 106, the floor 104 and a vertical sectional plane V extending between an edge of the roof top panel 110 and the floor 104 of the roof channel 120, and also extending in a direction corresponding to a longitudinal extension of the body side wall 106. The edge of the roof top panel 110 is herein an edge at the roof channel 120. Thereby, the engagement member 3′ can more easily connect with the vehicle bracket 130′, thereby reducing the risk of e.g. damaging the roof top panel 110.

The one or more protrusions 132 extend from the body side wall 106. Additionally, or alternatively, the one or more protrusions may extend from the vertical sectional plane V, and/or the one or more protrusions may extend between the body side wall 106 and the vertical sectional plane V.

The one or more protrusions may be T-shaped, mushroom shaped, eye-let shaped, and/or may comprise cut-outs, so that the engagement member 3′ of the roof rack 1 can engage with the one or more protrusions 132. In the embodiment shown in FIGS. 4a-c, the one or more protrusions 132, herein two protrusions, are mushroom shaped. The engagement member 3′ comprises a corresponding engaging portion 34′ which is connectable with the one or more protrusions 132. More particularly, the engaging portion 34′ comprises two slots for receiving and securing the mushroom shaped protrusions 132.

As further shown in FIG. 4a, the vehicle bracket 130′ may be attached to the floor 104, to the body side wall 106 and to a floor portion beneath the roof top panel 110. Thereby, a secure and robust attachment is achieved, even though the roof channel 120 is relatively narrow. Alternatives are possible, such as the vehicle bracket 130′ may be attached to one or more of said surfaces.

FIG. 5 shows an alternative embodiment. In this embodiment, the same engagement member 3′ is used. However, the vehicle bracket 130″ is different. More particularly, the one or more protrusions 132 instead extend from the vertical plane V and towards the body side wall 106. Thereby, the risk of damaging the roof top panel 110 may be further reduced.

As further shown in e.g. FIGS. 4a and 5, the vehicle bracket 130′, 130″ may be inclined, such as L-shaped, as seen in a sectional plane which is perpendicular to a longitudinal extension of the roof channel 120, with one side attached to the floor 104 and the floor portion beneath the roof top panel 110, and another side optionally attached to the body side wall 106. In FIG. 4a, the other side is attached to the body side wall 106.

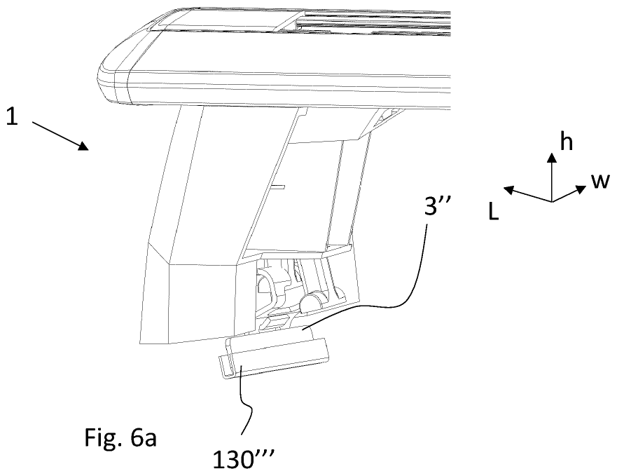

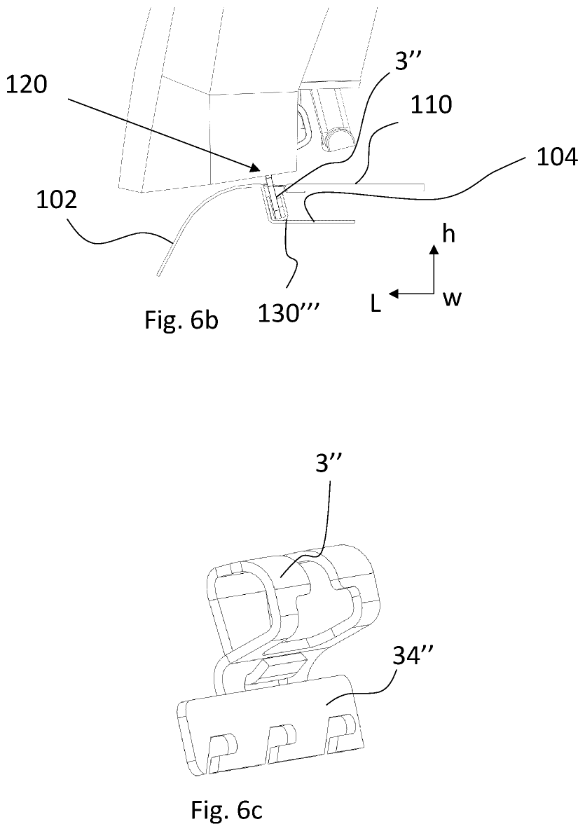

FIGS. 6a-c depict another embodiment where a vehicle bracket 130′″ is U-shaped, as seen in a sectional plane which is perpendicular to a longitudinal extension of the roof channel 120. More particularly, the U-shaped vehicle bracket 130′″ comprises one or more pin members extending across opposite side flanges of the U-shaped vehicle bracket 130″. A corresponding engaging portion 34″ of an engagement member 3″ is configured to engage with the one or more pin members. In the shown embodiment, the engaging member 3″ comprises three slots, or openings, in which a respective pin member can be received to secure the roof rack 1 to the vehicle roof 100. The engaging portion 34″ may comprise more or fewer slots to match the number of pin members of the vehicle bracket 130′″.

A portion of the vehicle bracket which comprises means for securing the roof rack 1 to the vehicle may be provided substantially in parallel with the body side wall 106, as seen in a sectional plane which is perpendicular to a longitudinal extension of the roof channel 120. Such configuration is for example shown in FIGS. 4a, 5, 6b and 7a. The portion may as shown in FIG. 5 be provided in parallel with and offset from the body side wall 106 so that a gap is formed between the portion and the body side wall 106. The portion may alternatively as shown in FIG. 4a be provided in parallel and in connection with the body side wall 106 so that a gap is formed between the portion and the roof top panel 110.

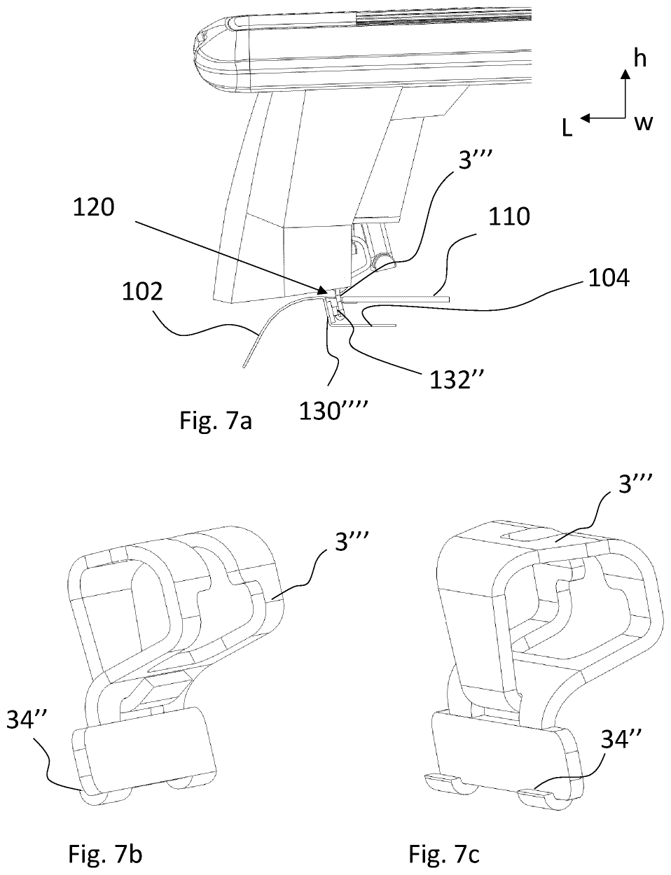

FIGS. 7a-c show an alternative embodiment with a vehicle bracket 130″″ comprising cut-outs 132″ to engage with. Accordingly, a corresponding engaging member 3′″ is also shown which comprises a corresponding engaging portion 34′″, in this case hook-shaped members to engage with the cut-outs 132″.

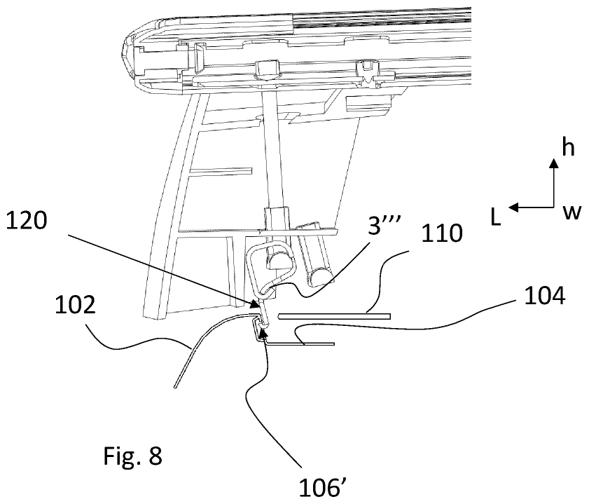

As shown in FIG. 8, a vehicle bracket 106′ may be an integral portion of the body side panel 102. In the shown embodiment, the vehicle bracket 106′ is an integral portion of the body side wall 106. As can be further gleaned from FIG. 8, the vehicle bracket 106′ may be formed as an overhang portion of the body side wall 106, and may be hook-shaped, as seen in a sectional plane which is perpendicular to a longitudinal extension of the roof channel 120. Thereby, the roof rack 1 may be attached to the vehicle in the roof channel 120 at any position along the roof channel. In other words, by this configuration, it is no longer a fix-point attachment. As such, a more flexible configuration is achieved.

The roof top panel 110 is typically a glass roof panel, even though also other types of roof top panels are feasible. For example, the roof top panel may be a standard roof top panel, such as made of aluminium or steel. Alternatively, the roof top panel may be any panel which is susceptible to damage, such as a carbon fiber light-weight roof top panel.

The vehicle brackets 130-130″″ may as shown be sheet metal elements, such as a bent sheet metal elements.

The roof channel 120 may have a channel opening width in the range of 5-20 mm, such as 5-15 mm or 5-10 mm.

Furthermore, the vehicle bracket 130-130′″ may as depicted herein be configured so that the engagement member 3′-3′″ of the roof rack 1 can engage with the vehicle bracket 130-130″″ by initially lowering the engagement member 3′-3′″ into the roof channel 120. This may be followed by moving the engagement member 3′-3′″ in a substantially horizontal direction, such as in a longitudinal direction of the roof channel 120, e.g. according to the embodiments depicted in FIGS. 6a-c, so that it engages with the vehicle bracket 130-130″″. Additionally, or alternatively, the engagement member 3′-3′″ may be moved in a width direction of the roof channel 120, e.g. according to the embodiments depicted in FIGS. 4a and 5, so that it engages with the vehicle bracket 130-130″″. Additionally, or alternatively, the engagement member 3′-3′″ may be rotated about an axis extending in the longitudinal extension of the roof channel 120 so that it engages with the vehicle bracket 130.

As shown in FIG. 4a, to engage the engagement member 3′ with the vehicle bracket 130′, the engagement member 3′ has to be moved in a width direction of the roof channel 120 which faces away from the roof top panel 110 and towards the body side wall 106. The opposite mounting direction is shown in FIG. 5. By the configuration as shown in FIG. 5, the risk of contacting the roof top panel during mounting may be further reduced.

It shall be noted that in FIGS. 1c, 6a-b, 7a and 8, the tightening member 4 may be gleaned in both its connected and disconnected state.

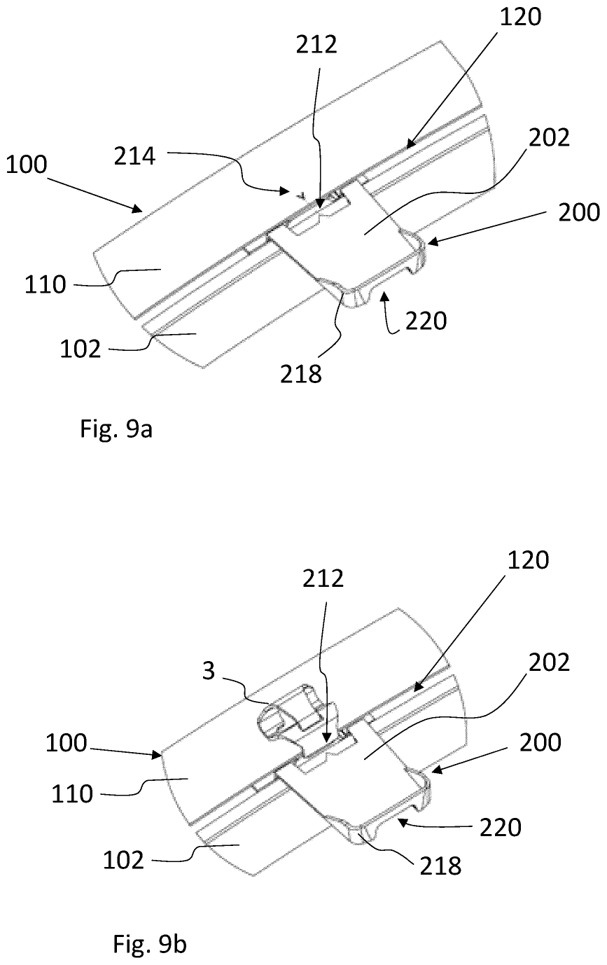

With reference to FIGS. 9-10 and 12, a roof rack alignment tool 200 according to example embodiments of the disclosure is depicted. The roof rack alignment tool 200 is a tool for aligning an engagement member 3 of a roof rack 1 to a vehicle bracket 130 of a vehicle. For example, the engagement member may be an engagement member 3-3′″ as disclosed herein.

The roof rack alignment tool 200 comprises:
a first surface 202 for parallel alignment to a vehicle roof 110, e.g. the roof top panel 110 as mentioned in the above.

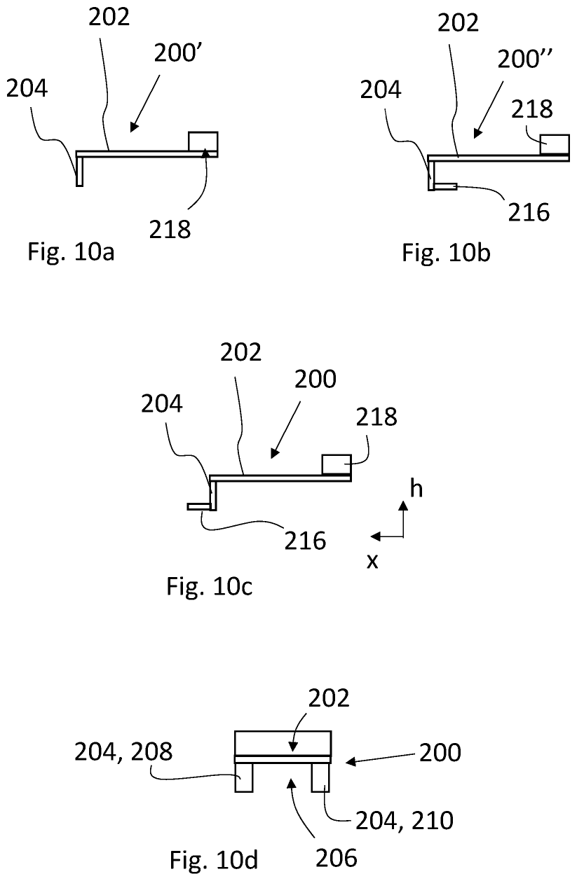

The roof rack alignment tool 200 further comprises:
a second surface 204 extending at an angle of substantially 90 degrees with respect to the first surface 202. The second surface 204 is configured to extend into a roof channel 120 of the vehicle roof 100 during use. Typically, the roof channel 120 comprises a cover, such as a rubber strap, which the tool 200 may push down when the second surface 204 extends into the roof channel 120. The second surface 204 is illustrated schematically in FIGS. 10a-c, showing side views of the tool 200.

As shown, the second surface 204 may be a folded portion of the first surface 202.

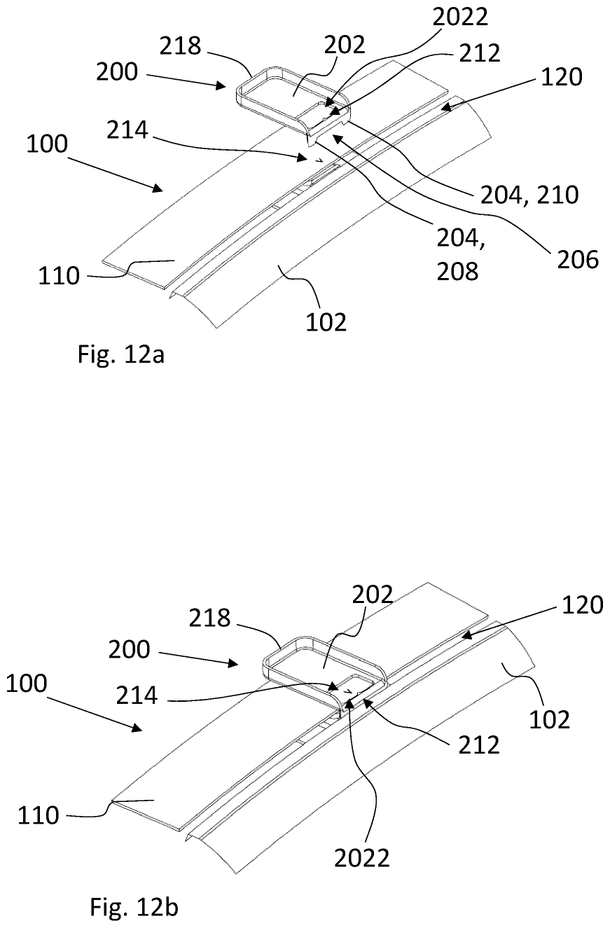

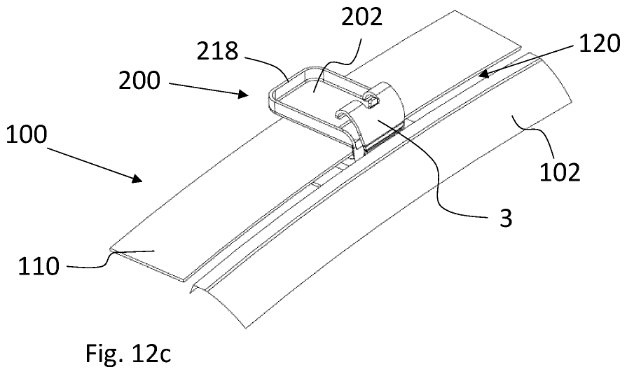

As further shown in FIG. 10d and in FIG. 12a, the second surface 204 may form a cut-out 206 for receiving the engagement member 3 of the roof rack 1 so that the engagement member 3 can engage with the vehicle bracket 130 of the vehicle therethrough. FIG. 10d shows a front side of the tool 200. For example, as disclosed herein, the engagement member 3 may preferably be rotated about an axis extending in the longitudinal extension of the roof channel 120 so that it engages with the vehicle bracket 130.

The second surface 204 may be formed by first and second leg portions 208, 210, wherein the cut-out 206 is formed in-between the first and second leg portions 208, 210.

The roof rack alignment tool 200 may further comprise a visual alignment indicator 212 for a user, such as an arrow 212, wherein the visual alignment indicator 212 is associated with the cut-out 206, such as provided mid-way in-between the first and second leg portions 208, 210. As shown, the visual alignment indicator 212 may be used to align with an alignment indicator 214 of the vehicle, such as an indicator which is provided on the roof top panel 110.

As shown in FIGS. 10b and 10c, the roof rack alignment tool 200 may further comprise a third surface 216 for aligning the tool 200 with the vehicle bracket 130 of the vehicle. The third surface 216 extends from an outer edge of the second surface 204. In the shown embodiments, the third surface 216 extends substantially in parallel with the vehicle roof 110 when the roof rack alignment tool 200 is in use.

The third surface 216 may as shown be a folded portion of the second surface 204.

The third surface 216 is typically formed by at least one auxiliary leg portion, such as the at least one auxiliary leg portion is an extension of the first 208 or the second 210 leg portion.

The third surface 216 may also be formed by two auxiliary leg portions, each auxiliary leg portion being an extension of the respective first 208 and second 210 leg portions.

In FIG. 10b, the first 202, second 204 and third 216 surfaces form a substantially U-shaped tool 200. In FIG. 10c, the first 202, second 204 and third 216 surfaces form a substantially step-shaped tool 200, as seen in sectional plane defined by a longitudinal extension x and a height extension h of the tool 200.

The roof rack alignment tool 200 is configured so that it can be moved in a longitudinal direction of the roof channel 120 until it reaches the vehicle bracket 130 of the vehicle, such as until the third surface 216 reaches the vehicle bracket 130 of the vehicle.

In the shown embodiments, the roof rack alignment tool 200 further comprises a fourth surface 218 for a user to grip on. The fourth surface 218 extends from an outer edge of the first surface 202, such as at an angle of substantially 90 degrees with respect to the first surface 202. The fourth surface 218 is provided on an opposite side of the roof rack alignment tool 200 with respect to the second surface 204. By substantially 90 degrees may herein be meant ±5 degrees or ±10 degrees from 90 degrees.

As can be gleaned from FIGS. 9a-b and 12a-c, the fourth surface 218 may extend around a corner of the first surface 202 to increase the rigidity of the fourth surface 218 and/or of the first surface 202. For example, as shown, the fourth surface 218 may extend around two corners of the first surface 202 at the opposite side of the roof rack alignment tool 200 such that three interconnected sub-surfaces are formed. As may be further gleaned in FIGS. 12a-c, the fourth surface 218 may extend around two corners of the first surface 202 at the opposite side of the roof rack alignment tool 200 such that three interconnected sub-surfaces are formed, and such that the fourth surface 218 extends completely between the opposite side and the second surface 204. In FIGS. 9a-b, the fourth surface 218 extends partially from the opposite side to the second surface 204.

As can be further gleaned from FIGS. 9a-b, the fourth surface 218 may form a cut-out 220 for a user to grip in.

As shown in FIGS. 12a-c, the first surface 202 may comprise a window 2022 defining an opening. The visual alignment indicator 212 may be associated with the window 2022. In the shown example, the visual alignment indicator 212 is formed as a tooth member on an edge of the window 2022. The window 2022 may be configured such that the alignment indicator 214 of the vehicle is visually identifiable in the window 2022 when the second surface 204 is provided in the roof channel 120.

In the example shown in FIGS. 9a-b, the first surface 202 of the roof rack alignment tool 200 is configured to extend over the body side panel 102 when the roof rack alignment tool 200 is in use, i.e., when the second surface 204 extends into the roof channel 120. Additionally, or alternatively, as shown in FIGS. 12a-c, the first surface 202 of the roof rack alignment tool 200 may be configured to extend over the roof top panel 110 when the roof rack alignment tool 200 is in use, i.e., when the second surface 204 extends into the roof channel 120. Thereby, the risk of scratching the body side panel 102 and/or the roof top panel 110, such as a glass roof, may be mitigated.

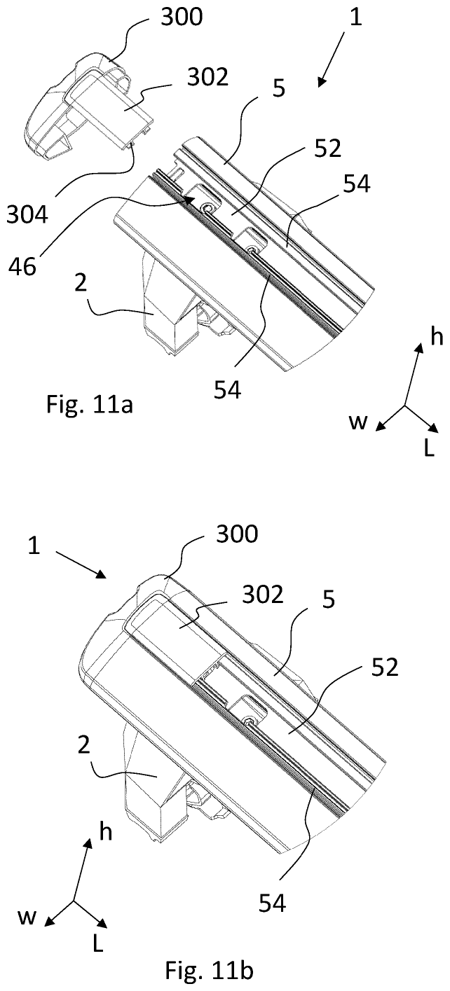

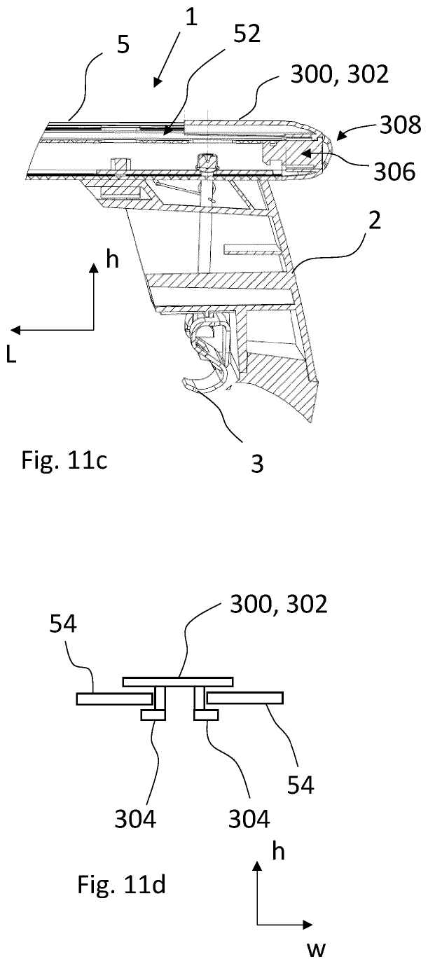

With reference to FIGS. 11a-d, a roof rack 1 and an end cap 300 according to example embodiments of the present disclosure are shown.

The roof rack 1 may have a cross bar member 5 and a roof rack foot member 2 as disclosed herein, although other configurations are also feasible.

The roof rack 1 as shown in FIGS. 11a-c comprises:
a cross bar member 5 for carrying a load on the vehicle, wherein the cross bar member 5 comprises a longitudinally extending cross bar channel 52.

The cross bar channel 52 may for example by used for securing a load to the cross bar member 5, such as used for securing a roof box, a bike carrier or the like. The cross bar channel 52 may for example be used for providing a T-shaped nut therein (not shown), which can be used for securing the load.

The roof rack 1 further comprises an end cap 300 for the cross bar member 5. The end cap 300 comprises a cover 302 for covering an end portion of the cross bar channel 5. In addition, the cross bar channel 52 comprises cover engaging flanges 54 for engaging with an engaging portion 304 of the cover 302 when the end cap 300 is mounted to the cross bar member 5.

In the shown embodiment, the cover engaging flanges 54 extend in a longitudinal direction L of the cross bar channel 52.

Furthermore, the cover engaging flanges 54 and the engaging portion 304 of the cover 302 are configured to allow longitudinal sliding movement of the cover 302 in the cross bar channel 52 and to prevent movement of the cover 302 in an upward direction h from the cross bar channel 52.

The end portion of the cross bar channel 5 comprises a tightening tool engaging portion 46 for tightening and releasing the roof rack 1 to/from the vehicle by use of a tightening tool (not shown), wherein the cover 302 is adapted for preventing unauthorized access to the tightening tool engaging portion 46. In the shown embodiment, the cover 302 is provided above the tightening tool engaging portion 46 and thereby prevents a user to access the tightening tool engaging portion 46 from above when the end cap 300 is mounted on the cross bar member 5.

As shown in FIG. 11b, when the end cap 300 is mounted to the cross bar member 5, the cover 302 is substantially flush with an outer surface of the cross bar member 5.

The other portions of the cross bar channel 52 which are not covered by the cover may instead be covered by e.g. a rubber strap cover (not shown), or anything similar.

With reference to FIG. 11d, the end cap 300 and the cover engaging flanges 54 are shown in a sectional plane being perpendicular to a longitudinal extension L of the end cap 300 and the cross bar member 5. As shown, the engaging portion 304 of the cover 302 may be T-shaped. Accordingly, the cover engaging flanges 54 may extend in the width extension w so that they prevent the cover 302 from being moved upwardly in the height direction h.

The engaging portion 304 of the cover 302 may at least be provided at a longitudinally outer end of the cover 302.

Furthermore, as can be gleaned from FIG. 11c, the end cap 300 may comprise a lock cylinder 306 for locking the end cap 300 to the cross bar member 5. Accordingly, a user may lock the end cap 300 to the cross bar member 5 by rotating the lock cylinder about an axis which extends in the longitudinal extension L of the cross bar member 5. A key may be used for this purpose, which is inserted into the lock cylinder 306 at an outer end face 308 of the end cap 300.

The disclosure also relates to the end cap 300 for a roof rack cross bar member 5 of a roof rack 1. The end cap 300 comprises:
the cover 302 for covering the end portion of a cross bar channel 52, wherein the cover comprises the engaging portion 304 for engaging with the cover engaging flanges 54 of the cross bar channel 52 when the end cap 300 is mounted to the cross bar member 5.

The cover 302 may have a length of 20-200 mm, such as 40-150 mm or 40-100 mm.

It is to be understood that the present invention is not limited to the embodiments described above and illustrated in the drawings; rather, the skilled person will recognize that many changes and modifications may be made within the scope of the appended claims.

1-19. (canceled)

20. A roof rack for a vehicle, comprising:
a roof rack foot member comprising a vehicle roof support surface;
an engagement member configured to engage a vehicle bracket of the vehicle;
a tightening member configured to tighten the engagement member; and
a cross bar member configured to carry a load on the vehicle,
wherein the tightening member is configured to couple to the roof rack foot member and the cross bar member to secure the roof rack to the vehicle,
wherein the tightening member comprises a first engagement section and the engagement member comprises a second engagement section, and
wherein the first engagement section and the second engagement section are configured to mate and tighten the engagement member to the vehicle bracket.

21. The roof rack according to claim 20, wherein the roof rack comprises a width extension, a height extension, and a longitudinal extension corresponding to a longitudinal extension of the cross bar member, and wherein the first engagement section is configured to connect to the second engagement section in a first connection direction which is different from a direction of the height extension.

22. The roof rack according to claim 20, wherein the first engagement section is configured to tighten the engagement member to the vehicle bracket by a first tightening force exerted on the second engagement section, wherein the engagement member comprises an engaging portion configured to engage the vehicle bracket, wherein the tightening member is configured to tighten the engaging portion to the vehicle bracket so that a second tightening force is exerted on the engaging portion by the vehicle bracket, wherein the engagement member is configured so that the second tightening force and the first tightening force are substantially aligned.

23. The roof rack according to claim 22, wherein the tightening member and the engagement member are configured such that the second tightening force and the first tightening force are substantially aligned with a center axis of the tightening member, wherein the center axis of the tightening member corresponds to a longitudinal extension of the tightening member.

24. The roof rack according to claim 20, wherein the engagement member comprises an engaging portion configured to engage the vehicle bracket and wherein the tightening member comprises a cross bar engaging portion configured to engage the cross bar member, wherein the tightening member is configured to transfer forces along a substantially straight line from the engaging portion to the cross bar engaging portion.

25. The roof rack according to claim 20, wherein the second engagement section comprises an opening configured to receive the first engagement section in a first connection direction.

26. The roof rack according to claim 20, wherein the first engagement section is T-formed, L-formed, J-formed, or ball-formed.

27. The roof rack according to claim 20, further comprising a biasing member configured to bias the tightening member towards a disconnected state with respect to the engagement member.

28. The roof rack according to claim 20, wherein the roof rack foot member comprises a guide surface for the tightening member, wherein the guide surface is configured to align the first engagement section with respect to the second engagement section or wherein the guide surface is configured to accommodate forces exerted on the tightening member which are directed in directions different from a longitudinal extension of the tightening member.

29. The roof rack according to claim 28, wherein the guide surface is configured to guide the tightening member in a guiding direction between a disconnected state and a first connected state, wherein the guiding direction corresponds to a longitudinal extension of the cross bar member.

30. The roof rack according to claim 20, wherein the engagement member is a hook member.

31. The roof rack according to claim 30, wherein the engagement member is a hook member and comprises a shape selected from the group consisting of the letter C, the letter L, the letter J, the letter U, and the number 9.

32. The roof rack according to claim 20, wherein the engagement member is configured to detach from the roof rack.

33. The roof rack according to claim 20, wherein the engagement member comprises a bent sheet-metal element, and wherein the engagement member forms an open hook end or wherein the engagement member forms a closed loop end.

34. The roof rack according to claim 20, wherein the vehicle roof support surface is adapted to only rest on a vehicle roof surface of the vehicle which is provided on one side with respect to the vehicle bracket, as seen in a direction corresponding to the longitudinal extension of the cross bar member.

35. The roof rack according to claim 34, wherein the tightening member is coupled to the roof rack foot member and the cross bar member so that the roof rack foot member is prevented from inclining inwards towards the vehicle when the tightening member tightens the engagement member.

36. The roof rack according to claim 34, wherein the other side with respect to the vehicle bracket is closer to a second roof rack foot member which is provided on an opposite side of the cross bar member, as seen in a direction corresponding to the longitudinal extension of the cross bar member.

37. The roof rack according to claim 20, wherein the roof rack foot member is configured to avoid contact with an adjacent glass roof panel of the vehicle when the roof rack is mounted on the vehicle.

38. The roof rack according to claim 20, wherein the first engagement section is configured to connect to the second engagement section by pivoting the tightening member, about an axis which is substantially perpendicular to a longitudinal extension of the tightening member, and wherein the tightening member is pivotable about an axis which extends along a width extension of the roof rack.

39. A method for mounting a roof rack to a vehicle, comprising:
aligning and positioning an engagement member of the roof rack to a vehicle bracket;
positioning a roof rack foot member comprising a vehicle roof support surface onto the vehicle so that a tightening member is aligned with the engagement member; and
tightening the engagement member.
